(19) United States
(12) Patent Application Publication
(10) Pub. No.: US 2024/0010870 A1
(43) Pub. Date: Jan. 11, 2024

(54) UV-BLOCKING COATINGS AND ANTI-FOGGING AND SUPERHYDROPHOBIC COATINGS

(71) Applicant: Bar-Ilan University, Ramat Gan (IL)

(72) Inventors: Shlomo MARGEL, Rehovot (IL); Taly ILINE-VUL, Petach Tikva (IL); Naftali KANOVSKY, Rehovot (IL); Sarit COHEN, Peduel (IL)

(21) Appl. No.: 18/022,155

(22) PCT Filed: Aug. 20, 2021
(86) PCT No.: PCT/IL2021/051023

§ 371 Date: Feb. 19, 2023

Related U.S. Application Data
(60) Provisional application No. 63/069,735, filed on Aug. 25, 2020.
(60) Provisional application No. 63/067,903, filed on Aug. 20, 2020.

(51) Int. Cl. C09D 183/06; C09D 7/40; B05D 5/08; B05D 1/36

(52) U.S. Cl. CPC C09D 183/06; C09D 7/40; B05D 5/08; B05D 1/36

(57) ABSTRACT

Compositions comprising a substrate and a silane-based polymer are disclosed. Coated substrates and articles comprising the compositions are also disclosed. Process of preparing the compositions and methods of using the same, such as for UV-blocking coatings are provided. Compositions comprising a substrate, a silane compound and a surfactant wherein a weight per weight (w/w) ratio of the silane compound and the surfactant is between 10:1 (w/w) to 40:1 (w/w) are disclosed. Coated substrates and articles comprising the compositions are also disclosed. Process of preparing the compositions and methods of using the same, such as for anti-fogging and superhydrophobic coatings are provided.

### CROSS REFERENCE TO RELATED APPLICATIONS

This application claims the benefit of priority to U.S. Provisional Patent Application Nos. 63/069,735 filed Aug. 25, 2020, entitled “Thin silane-based UV-blocking coatings on polymeric films”, and 63/067,903 filed Aug. 20, 2020, entitled “Engineering of durable thin mesoporous silica micro/nano-particle coatings onto polymeric films for industrial applications: anti-fogging protection and hydrophobic/superhydrophobic coatings”, the contents of which are incorporated herein by reference in their entirety.

### FIELD OF THE INVENTION

The present invention relates generally to the field of compositions comprising one or more silane-based compound or silica coatings and is directed to methods of using the same such as for ultra-violet light absorbing coatings or anti-fogging and superhydrophobic coatings.

### BACKGROUND OF THE INVENTION

Ultraviolet (UV) radiation is an invisible electromagnetic radiation with short wavelengths and high energies. The energy of the photons in the ultraviolet region (290-400 nm) is sufficient to break chemical bonds in polymers, wood, paper and other organic materials. UV light is responsible for the degradation, loss of strength, impact resistance, and mechanical properties of polymers. Moreover, UV light can damage human tissue and can affect the immune system. Therefore, reducing the effective lifetime of UV irradiation by protecting light-sensitive materials is an important technological demand in the vast majority of industrial fields.

Anti-fogging (AF) agents are used to coat plastic films forming a continuous and uniform transparent layer of water preventing fog formation. Coatings that reduce the tendency for surfaces to “fog up” have been reported. These so-called anti-fogging coatings improve the wettability of a surface by allowing a thin layer of water film to form on the surface instead of discrete droplets. The degree of hydrophilicity of surfaces, measured by water droplet contact angle, provides a measure for their anti-fogging ability. Generally, surfaces with a water contact angle degree of less than 40° may often explored as anti-fog surfaces.

Superhydrophobic surfaces have received rapidly increasing research interest because of their tremendous application potential in areas such as self-cleaning and anti-icing surfaces, drag reduction, and enhanced heat transfer. A surface is considered superhydrophobic if a water droplet beads up (with contact angles >150°), and moreover, if the droplet can slide away from the surface readily (i.e., it has small contact angle hysteresis). This behavior, known as the lotus or self-cleaning effect, is found to be a result of the hierarchical rough structure, as well as the wax layer present on the leaf surface. Superhydrophobic surfaces exhibit a low surface energy and are not wetted by water. This means that water forms a droplet that may easily roll off if the surface is tilted; while rolling off, the droplet may also remove dirt from the surface, known as a self-cleaning or lotus leaf effect. It is well-known that the superhydrophobic property is the result of a combination of desired surface roughness and low surface energy of certain materials.

The preparation of optical quality durable thin-film coatings with good coating characteristics and mechanical durability is still a great challenge. There is a need for new and easy methods for preparation of super-hydrophobic and super-hydrophilic coatings that maintain both its desired attributes and a good mechanical durability.

### SUMMARY OF THE INVENTION

In one aspect of the invention, there is provided a coated substrate comprising a substrate, and a silane-based polymer, wherein: i) the silane-based polymer is covalently bound to at least a portion of the substrate, forming a coating layer, and ii) the silane-based polymer is represented by or comprises Formula I:

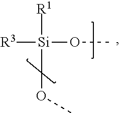

wherein: R³ comprises an aromatic UV absorbing functional group; R¹ represents hydrogen, or is selected from the group comprising -----O, optionally substituted C₁-C₆ alkyl, —O(C₁-C₆ alkyl), —OH, or a combination thereof; ------ represents a covalent bond to i) the substrate, or ii) to an adjacent monomer; and wherein the silane-based polymer comprises at least one covalent bond to the substrate.

In some embodiments, R³ is represented by or comprises Formula Ic:

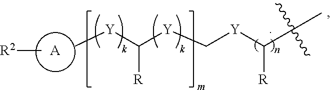

wherein: A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl; each Y independently represents C, CH, CH₂, or O; n is a integer ranging from 1 to 5; each k is a integer ranging from 0 to 5; m is a integer ranging from 0 to 5; and each of R and R² independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof.

In some embodiments, the silane-based polymer is represented by or comprises Formula II:

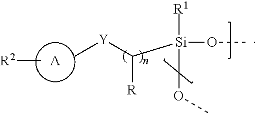

In some embodiments, the silane-based polymer is represented by or comprises Formula IIIa: Formula IIIb:

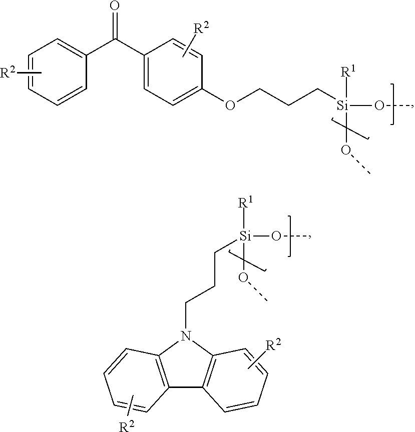

### or Formula Mc:

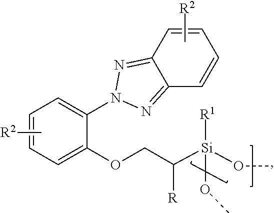

In some embodiments, the silane-based polymer is derived from a monomer represented by any one of:

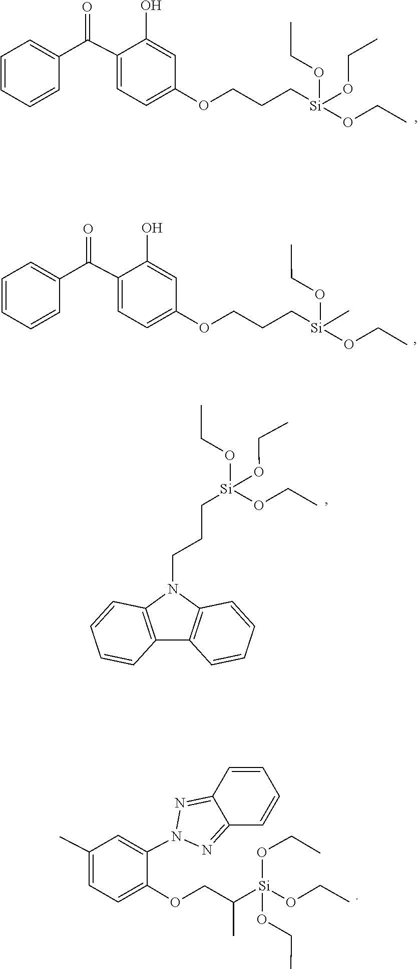

In some embodiments, the substrate comprises an at least partially oxidized surface comprising a plurality of hydroxy groups.

In some embodiments, the coating layer is characterized by a dry thickness between 0.2 μm and 50 μm.

In some embodiments, the coated substrate comprises at least two of the coating layers.

In some embodiments, the coated substrate further comprises between 0.01% (w/w) and 0.2% (w/w) of a surfactant selected from the group consisting of: cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyidimethylammonium bromide (DEDTAB), decyltrimethylammonium bromide (D10TAB), dodecyltriphenylphosphonium bromide (DTPB), or any combination thereof.

In some embodiments, the substrate is selected from the group consisting of: a polymeric substrate, a paper substrate, a glass substrate, and any combination thereof.

In some embodiments, the polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

In some embodiments, the coating layer is characterized by an ultraviolet (UV) transmission of less than 60%.

In some embodiments, the coating layer is characterized by a visible light transmission (VLT) between 80% and 99%.

In some embodiments, the coating layer is characterized by a haze between 6% and 20%.

In some embodiments, the coated substrate is characterized by a shrinkage between 1% and 40%, obtained by thermal shrinkage process.

In some embodiments, the coated substrate is characterized by improved UV-blocking transmission.

In another aspect of the invention, there is provided an article comprising the coated substrate of the present invention.

In some embodiments, the article is selected from the group consisting of: transparent plastic surface, lenses, package, and windows.

In another aspect of the invention, there is provided a process for obtaining a coated substrate, comprising the steps of: (a) providing at least partially oxidized substrate comprising a plurality of hydroxy groups; and (b) contacting the substrate with a composition comprising: (i) a silane-based monomer, wherein the silane-based monomer is represented by or comprises Formula Id:

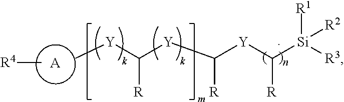

wherein: A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl; each Y independently represents C, CH, CH₂, or O; n is a integer ranging from 1 to 5; each k is a integer ranging from 0 to 5; m is a integer ranging from 0 to 5; each of R¹, R², R³ independently represents hydrogen, or is selected from the group comprising optionally substituted C₁-C₆ alkyl, —O(C₁-C₆ alkyl), —OH, or a combination thereof, wherein at least one R′, R² or R³ represents the substituent; and each of R, R⁴ independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; and (ii) a solvent, a surfactant or both, under conditions suitable for the silane-based monomer to polymerize and covalently bound to the substrate, thereby forming a coating layer on the substrate.

In some embodiments, the coated substrate is the coated substrate of the present invention.

In some embodiments, the process further comprises a step (c) of washing the substrate to remove non-bound silane-based monomer.

In some embodiments, the contacting is selected from the group comprising: dipping, spraying, spreading, casting, rolling, adhering, printing, curing, or any combination thereof.

In some embodiments, the silane-based monomer is represented by or comprises Formula II:

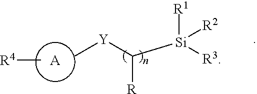

In some embodiments, the silane-based monomer is represented by or comprises Formula IIIa: Formula Mb:

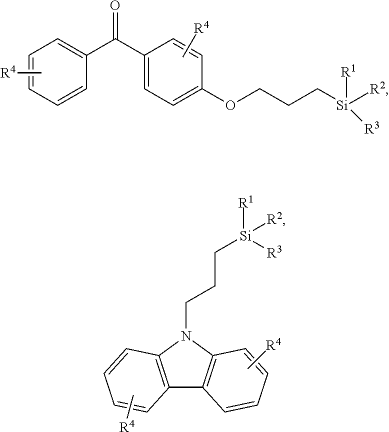

### or Formula IIIc:

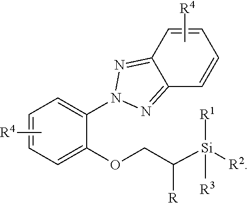

In some embodiments, the silane-based monomer is represented by or comprises any one of:

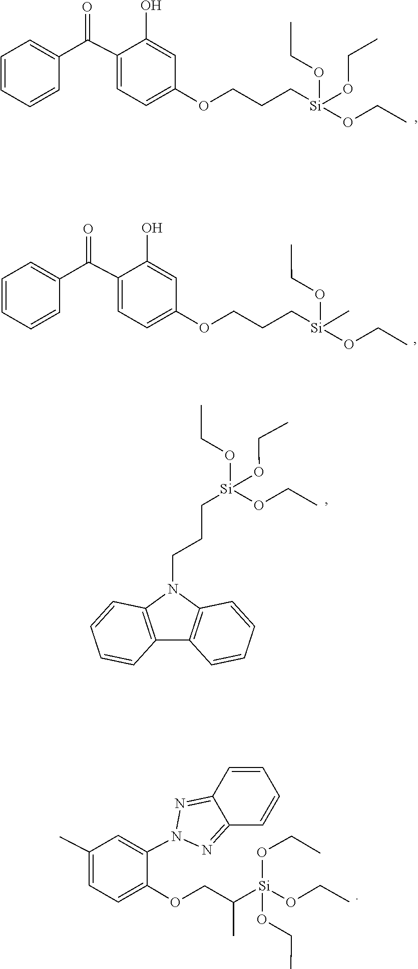

In some embodiments, the coating layer is characterized by a wet thickness between 80 μm and 200 μm.

In some embodiments, the solvent is a protic solvent selected from the group consisting of: water, ethanol, methyl ethyl ketone, isopropanol, methanol, butanol and any combination thereof.

In some embodiments, the surfactant selected from the group consisting of: cetyltrimethylammonium bromide (CTAB), cetyltrimethylammonium chloride (CTACl), etradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyidimethylammonium bromide (DEDTAB), decyltrimethylammonium bromide (D10TAB), dodecyltriphenylphosphonium bromide (DTPB), and any combination thereof.

In some embodiments, the composition comprises between 0.01% (w/w) and 0.2% (w/w) of the surfactant.

In some embodiments, the composition comprises between 0.5% (w/w) and 10% (w/w) of the silane-based monomer.

In some embodiments, the substrate is selected from the group consisting of: a polymeric substrate, a paper substrate, a glass substrate, and any combination thereof.

In some embodiments, the polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

In some embodiments, the process is for receiving a UV-blocking coated substrate.

In another aspect of the invention, there is provided a coated substrate comprising a substrate and mesoporous SiO₂-coating, wherein: i) the mesoporous SiO₂-coating is covalently bound to at least a portion of the substrate, forming a first coating layer; ii) the first coating layer is characterized by a dry thickness between 0.001 μm and 10 μm; and iii) the first coating layer is characterized by a roughness between 1 nm and 100 nm, as measured by Atomic Force Microscope (AFM).

In some embodiments, the substrate is selected from the group consisting of: a polymeric substrate, a paper substrate a glass substrate, and any combination thereof.

In some embodiments, the polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

In some embodiments, the coated substrate is characterized by a water contact angle on the surface of the first coating layer of less than 40°.

In some embodiments, the coated substrate is characterized by a water contact angle on the surface of the first coating layer between 40° and 1°.

In some embodiments, the coated substrate further comprises a second coating layer, comprising a hydrophobic agent selected from 1H,1H,2H,2H-perfluorododecyl trichlorosilane (FTS), octadecyl trichlorosilane (OTS), 1H,1H,2H,2H-perfluorodecyl triethoxysilane (FTES), octadecyl triethoxysilane (OTES), and any combination thereof.

In some embodiments, the hydrophobic agent is covalently bound to the mesoporous SiO₂-coating, or to the first coating layer.

In some embodiments, the coated substrate is characterized by a water contact angle on the surface of the second coating layer of at least 130°.

In some embodiments, the coated substrate is characterized by a water contact angle on the surface of the second coating layer between 130° and 165°.

In some embodiments, the coated substrate is characterized by a roughness between 70 nm and 150 nm, as measured by AFM.

In some embodiments, the coated substrate is characterized by a haze between 8.5% and 20%.

In some embodiments, the coated substrate is characterized by a gloss between 25% and 49%.

In another aspect of the invention, there is provided a process for obtaining a coated substrate with a mesoporous SiO₂-coating, comprising the steps of: (a) providing a substrate selected from an hydrophilic substrate, or an at least partially oxidized substrate; and (b) contacting the substrate with a composition comprising (i) a silane compound represented by the formula Si(OR)₄, Si(R′)ₙ(0R)₄₋ₙ or a combination thereof, wherein R and R′ are each independently selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; and (ii) a surfactant, wherein a weight per weight (w/w) ratio of the silane compound and the surfactant is between 10:1 (w/w) to 40:1 (w/w), under conditions suitable for forming the mesoporous SiO₂-coating, and bound the mesoporous SiO₂-coating to the substrate, thereby forming a first coating layer on the substrate.

In some embodiments, the coated substrate is the coated substrate of the present invention.

In some embodiments, the process further comprises a step (c) of washing the substrate to remove non-bound mesoporous SiO₂-coating.

In some embodiments, the process is for receiving an anti-fogging coated substrate.

In some embodiments, the process further comprises step (d) contacting the substrate with a solution comprising a hydrophobic agent selected from 1H,1H,2H,2H-perfluorododecyl trichlorosilane (FTS), octadecyl trichlorosilane (OTS), 1H,1H,2H,2H-perfluorodecyl triethoxysilane (FTES), octadecyl triethoxysilane (OTES), and any combination thereof, thereby forming a second layer.

In some embodiments, the process is for receiving a coated substrate characterized by a water contact angle of at least 130°.

In some embodiments, the process is for receiving a superhydrophobic coated substrate.

In some embodiments, the contacting is selected from the group comprising: dipping, spraying, spreading, casting, rolling, adhering, printing, curing, or any combination thereof.

In some embodiments, the coating layer is characterized by a wet thickness between 2 μm and 20 μm.

In some embodiments, the surfactant is selected from the group consisting of: cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyidimethylammonium bromide (DEDTAB), decyltrimethylammonium bromide (D10TAB), dodecyltriphenylphosphonium bromide (DTPB), or any combination thereof.

In some embodiments, the composition comprises a protic solvent selected from the group consisting of: water, ethanol, methyl ethyl ketone, isopropanol, methanol, butanol and any combination thereof.

In some embodiments, the composition comprises water and ethanol at a ratio between 1:2 and 1:10.

In some embodiments, the composition comprises between 5 mM and 40 mM of a base selected from NH₄OH, KOH, NaOH, or a combination thereof.

In some embodiments, the composition comprises between 0.01% weight per volume (w/v) and 5% (w/v) of the surfactant.

In some embodiments, the composition comprises between 50 mM and 80 nM of the silane compound.

In some embodiments, the substrate is selected from the group consisting of: a polymeric substrate, a paper substrate, a glass substrate, and any combination thereof.

In some embodiments, the polymeric substrate comprises a polymer selected from the group consisting of: polyethylene (PE), polypropylene (PP), polyethylene terephthalate (PET), PET derivatives, polymethylmethacrylate(PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

In some embodiments, the process is devoid of a curing agent.

In some embodiments, the composition further comprises a hydrophobic agent selected from 1H,1H,2H,2H-perfluorododecyl trichlorosilane (FTS), octadecyl trichlorosilane (OTS), 1H,1H,2H,2H-perfluorodecyl triethoxysilane (FTES), octadecyl triethoxysilane (OTES), and any combination thereof.

In some embodiments, the hydrophobic agent is covalently bound to the mesoporous SiO₂-coating.

In some embodiments, the composition further comprises a silane coupling agent selected from the group consisting of: 3-(Methacryloyloxy)propyl]trimethoxysilane (MPS), 3-(aminooxy)propyl]trimethoxy silane (APS), uridopropyltrimethoxysilane, trialkylpropypylmelaminesilane, triethoxysilylpropyl hydantoin and any combination thereof.

In some embodiments, the composition further comprises a stabilizer selected from the group consisting of: polyethyleneglycol diacrylate (PEGDA), polyvinylpyrrolidone (PVP), polyethylene glycol (PEG), including any mixture or any copolymer thereof.

In some embodiments, a w/w concentration of the stabilizer within the composition is between 0.01 and 5%, between 0.01 and 0.05%, between 0.05 and 0.1%, between 0.1 and 0.2%, between 0.2 and 0.5%, between 0.5 and 1%, between 1 and 5%, including any range between.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 Presents the chemical structure of 2-hydroxy-4-(3-triethoxysilylpropoxy) diphenylketone (SiUV);

FIG. 2 is a schematic representation of the thin coating process onto polymeric films of the UV absorbing silane polymer formed by polymerization of the UV absorbing SiUV monomer in ethanol/water continuous phase in absence or presence of a mesoporous surfactant former, (e.g. CTAB or STAC);

FIG. 3 is a schematic representation demonstrating that the increasing in the thickness of the produced polymeric coating on the PE films increased the UV absorbance of the films, up to 100%;

FIGS. 4A-C are high resolution scanning electron microscopy (HRSEM) images of: corona-treated PE film (FIG. 4A), a PE film with one layer of SiUV coating (FIG. 4B) and a PE film with two layers of SiUV coating (FIG. 4C);

FIG. 5 is an attenuated total reflection (ATR) spectra of PE films with and without SiUV coatings. The spectrum contains graphs of corona treated PE, PE layered once with SiUV coating (PE-SiUV_1 Layer) and PE layered twice with SiUV coating (PE-SiUV_1 Layer);

FIG. 6 is a UV-vis transmission spectra of the corona-treated PE films with and without SiUV coatings. The spectrum contains graphs of corona treated PE, PE layered once with SiUV coating (PE-SiUV_1 Layer) and PE layered twice with SiUV coating (PE-SiUV_2 Layer);

FIG. 7 is a UV-vis transmission spectra of corona-treated PE films in presence and absence of SiUV coatings. The spectrum contains graphs of corona treated PE, PE layered once with SiUV coating with different concentrations of the SiUV monomer;

FIG. 8 is a UV-vis transmission spectra of the PE films with SiUV coatings after the 30% shrinkage. The spectrum contains graphs of corona treated PE layered once with SiUV coating (PE-SiUV_1 Layer) and PE layered twice with SiUV coating (PE-SiUV_2 Layer);

FIGS. 9A-B present the chemical structure of FTS (FIG. 9A) and OTS (FIG. 9B);

FIGS. 10A-B present the chemical structure of FTES (FIG. 10A) and OTES (FIG. 10B);

FIGS. 11A-D are pictures presenting the different grades given to polymeric films after a hot fog test: a thin, transparent layer of water with no optical damage (FIG. 11A), large, separate drops on the film surface resulting in less transparency (FIG. 11B), medium, separate drops on the film surface resulting in little transparency (FIG. 11C), and small, separate drops on the film surface resulting in a foggy surface (FIG. 11D);

FIGS. 12A-F are HRSEM images of a corona treated roughened PP (r-PP) film (FIG. 12A) and the resulting coated films using different percentages (w/v) of CTAB/CTAC: 0.04% (FIG. 12B), 0.1% (FIG. 12C), 0.5% (FIG. 12D), 1% (FIG. 12E) and 2% (FIG. 12F);

FIGS. 13A-C are atomic force microscopy (AFM) images of: corona treated roughened PP (r-PP) film (FIG. 13A), SiO₂ particle coating on the r-PP film prepared in absence of CTAB (FIG. 13B) (Table 1, sample 1), and MSP coating on the r-PP film (FIG. 13C) (Table 1, sample 3); and

FIGS. 14A-D are XPS spectra of a non-mesoporous coated r-PP film, r-PP/MSP film and r-PP/MSP-FTS film (FIG. 14A); magnification of the r-PP/MSP-FTS film spectra depicting the peaks corresponding to Si 2p (FIG. 14B), F 1s (FIG. 14C) and C 1s (FIG. 14D).

### DETAILED DESCRIPTION OF THE INVENTION

According to some embodiments, the present invention provides a coated substrate comprising a substrate, and a silane-based polymer. In some embodiments, the silane-based polymer is covalently bound to the substrate, forming a coating layer. In some embodiments, the silane-based polymer is an ultraviolet (UV) absorbing silane polymer. In some embodiments, the silane-based polymer is characterized by an absorbance at a wavelength between 200 nm and 450 nm, between 200 nm and 430 nm, between 200 nm and 420 nm, between 200 nm and 400 nm, between 200 nm and 390 nm, or between 200 nm and 380 nm, including any range therebetween. Each possibility represents a separate embodiment of the invention. In some embodiments, the silane-based polymer is an aromatic polysiloxane polymer.

According to some embodiments, the present invention provides a composition comprising: (i) a substrate, (ii) a UV absorbing silane-based monomer, a solvent, a surfactant or both.

The present invention is based, in part, on the finding that in-situ polymerization of a silane-based monomer in the presence of a substrate comprising hydroxy groups, results in the formation of a highly stable silane-based coating layer covalently bound to the substrate. In some embodiments, the silane-based coating layer is characterized by an improved UV absorbance.

The present invention is based, in part, on the finding that increasing the concentration of the UV absorbing silane-based monomer, or the thickness of the coating layer increases the UV absorbance of the coated substrate up to about 100%.

### Coated Substrates

According to an aspect of some embodiments of the present invention there is provided a coated substrate. In some embodiments, the coated substrate comprises a substrate, and a silane-based monomer covalently attached thereto. In some embodiments, the coated substrate comprises a substrate, and a silane-based monomer, wherein: i) the silane-based monomer is covalently bound to at least a portion of the substrate, forming a coating layer, and ii) the silane-based monomer is represented by or comprises Formula V:

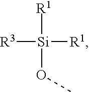

wherein: R³ comprises an aromatic UV absorbing functional group; each R¹ independently represents hydrogen, or is selected from the group comprising optionally substituted C₁-C₆ alkyl, —O(C₁-C₆ alkyl), —OH, or a combination thereof; and ------ represents a covalent bond to the substrate.

In some embodiments, the silane-based monomer is represented by or comprises Formula Va:

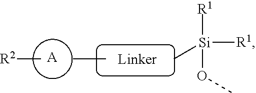

wherein: A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl. In some embodiments, each of R¹ independently represents hydrogen, or is selected from the group comprising optionally substituted C₁-C₆ alkyl, —O(C₁-C₆ alkyl), —OH, or a combination thereof. In some embodiments, R² represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof. In some embodiments, ------ represents a covalent bond to the substrate. In some embodiments, linker comprises a group, molecule or macromolecule connecting A to the silane group.

According to an aspect of some embodiments of the present invention there is provided a coated substrate. In some embodiments, the coated substrate comprises a substrate, and a silane-based polymer. In some embodiments, the coated substrate comprises a substrate, and a silane-based polymer, wherein: i) the silane-based polymer is covalently bound to at least a portion of the substrate, forming a coating layer, and ii) the silane-based polymer is represented by or comprises Formula I:

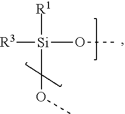

### or by Formula:

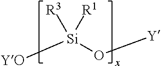

wherein: x represents an integer between 2 and 10.000; each Y′ independently represents H or a covalent bond to the substrate; R³ comprises an aromatic UV absorbing functional group; R¹ represents hydrogen, or is selected from the group comprising -----O, optionally substituted C₁-C₆ alkyl, —O(C₁-C₆ alkyl), —OH, or a combination thereof; ------represents a covalent bond to: i) the substrate, or ii) to an adjacent monomer; and wherein the silane-based polymer comprises at least one covalent bond to the substrate. In some embodiments, x is between 2 and 1000, between 2 and 100, between 2 and 20, between 20 and 50, between 50 and 100, between 2 and 10.000, between 100 and 200, between 200 and 500, between 500 and 1000, between 1000 and 5000, between 5000 and 10.000, including any range between.

In some embodiments, R³ is represented by or comprises Formula Ic:

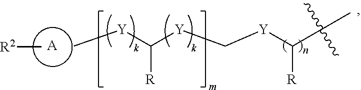

wherein: A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl; each Y independently represents C, CH, CH₂, or O; n is a integer ranging from 1 to 5; each k is a integer ranging from 0 to 5; m is a integer ranging from 0 to 5; and each of R and R² independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof.

In some embodiments, ------ represents a covalent bond to i) the substrate, and ii) an adjacent silane-based polymer represented by Formula I. In some embodiments, ------represents a covalent bond to i) the substrate, or ii) an adjacent monomer. In some embodiments, each of ------ represents a covalent bond to the substrate.

In some embodiments, the silane-based polymer is represented by or comprises Formula Ia:

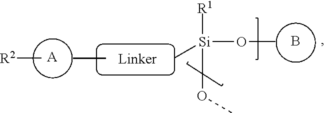

### or by Formula:

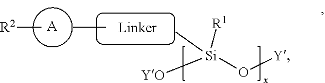

wherein:
A comprises a UV absorbing functional group, and R1, Y′, and x are as described herein. In some embodiments, A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl. In some embodiments, R¹ represents hydrogen, or is selected from the group comprising optionally substituted C₁-C₆ alkyl, —O(C₁-C₆ alkyl), —OH, or a combination thereof. In some embodiments, R² represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof. In some embodiments, ------ represents a covalent bond to the substrate.

In some embodiments, B represents hydrogen, optionally substituted C₁-C₆ alkyl, a silane-based polymer represented by Formula I, a silane based-monomer represented by formula V, or the substrate. As used herein “linker” refers to a molecule or macromolecule serving to connect different moieties or functional groups. According to the present invention, the linker is covalently bound to i) A comprising a UV absorbing functional group, and ii) to the silane group.

In some embodiments, the silane-based polymer is represented by or comprises Formula Ib:

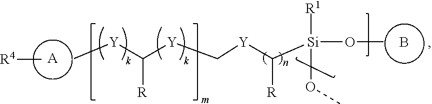

wherein: A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl; each Y independently represents C, CH, CH₂, or O; n is a integer ranging from 1 to 5; each k is a integer ranging from 0 to 5; m is a integer ranging from 0 to 5; R¹ represents hydrogen, or is selected from the group comprising optionally substituted C₁-C₆ alkyl, —O(C₁-C₆ alkyl), —OH, or a combination thereof; and each of R and R² independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; ------represents a covalent bond to the substrate; and B represents hydrogen, optionally substituted C₁-C₆ alkyl, a silane-based polymer represented by Formula I, a silane based-monomer represented by formula V, or the substrate.

In some embodiments, the silane-based polymer is represented by or comprises Formula Ie:

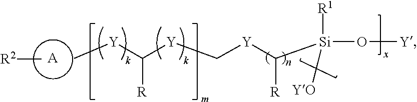

wherein A, Y, Y′ R¹, R², k, m and n are as described herein.

In some embodiments, the silane-based polymer is represented by or comprises Formula II:

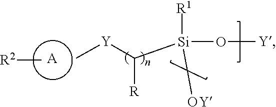

wherein A, Y, Y′, R¹, R² and n are as described herein.

In some embodiments, A comprises a UV absorbing functional group. As used herein, the term “UV absorbing” refers to compounds that absorb ultraviolet light. UV absorbing compounds, comprise functional groups (chromophores) that contain valence electrons of low excitation energy.

In some embodiments, the UV absorbing functional group is characterized by an UV absorbance between 60% and 100%, between 65% and 100%, between 70% and 100%, between 80% and 100%, between 90% and 100%, between 95% and 100%, between 60% and 99%, between 65% and 99%, between 70% and 99%, between 80% and 99%, between 90% and 99%, between 95% and 99%, between 60% and 98%, between 65% and 98%, between 70% and 98%, between 80% and 98%, between 90% and 98%, between 95% and 98%, between 60% and 95%, between 65% and 95%, between 70% and 95%, between 80% and 95%, between 90% and 95%, between 60% and 80%, between 65% and 80%, or between 70% and 80%, including any range therebetween, as measured according to ASTM D1003. Each possibility represents a separate embodiment of the invention. As used herein, the term “UV absorbance”, refers to the percentage of the incoming UV light intensity absorbed by the UV absorbing functional group or coating layer.

In some embodiments, the silane-based polymer is represented by or comprises

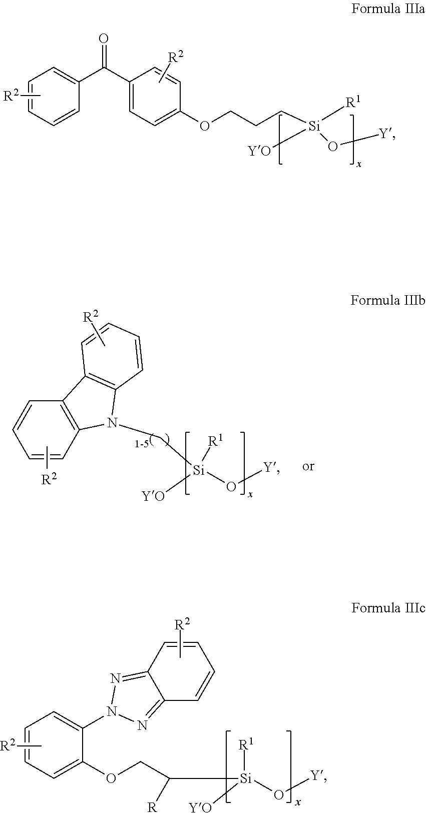

wherein Y′, x, R, R¹ and R² are as described herein.

In some embodiments, the silane-based polymer is derived from a monomer represented by any one of:

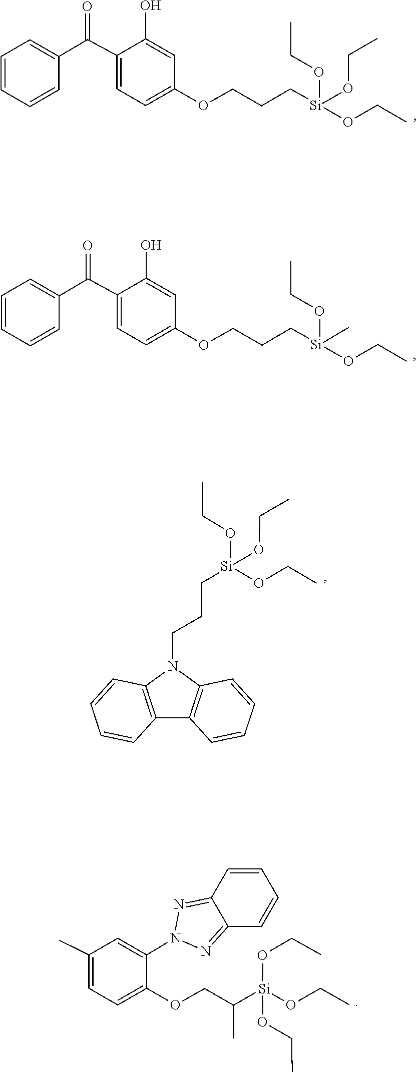

In some embodiments, the outer surface of the substrate comprises a plurality of hydroxy groups.

According to one aspect, there is provided a composition comprising a partially oxidized substrate comprising a plurality of hydroxy groups and a silane-based polymer as described hereinabove, wherein the silane-based polymer is linked to a portion of (and/or at least one surface of) the substrate, in the form of a first layer. In some embodiments, the silane-based polymer is covalently bound to a portion of (and/or at least one of) the hydroxy groups of the substrate.

The terms, film/films and layer/layers are used herein interchangeably. As used herein, the term “coat” refers to the combined layers disposed over the substrate, excluding the substrate, while the term “substrate” refers to the part of the composite structure supporting the disposed layer/coating. In some embodiments, the terms “layer”, “film” or as used herein interchangeably, refer to a substantially uniform-thickness of a substantially homogeneous substance.

The chemistry and morphological properties of the layers, e.g., disposed on top of the substrate, are discussed herein below in the Example section. Moreover, according to one embodiment of the present invention, the layer is homogenized deposited on a surface. In some embodiments, the desired dry thickness of the first layer of the disclosed polymer is characterized by a thickness between 0.2 μm and 50 μm, between 0.7 μm and 50 μm, between 0.9 μm and 50 μm, between 1 μm and 50 μm, between 1.2 μm and 50 μm, between 1.5 μm and 50 μm, between 2 μm and 50 μm, between 5 μm and 50 μm, 0.2 μm and 25 μm, between 0.7 μm and 25 μm, between 0.9 μm and 25 μm, between 1 μm and 25 μm, between 1.2 μm and 25 μm, between 1.5 μm and 25 μm, between 2 μm and 25 μm, between μm and 25 μm, 0.5 μm and 10 μm, between 0.7 μm and 10 μm, between 0.9 μm and 10 μm, between 1 μm and 10 μm, between 1.2 μm and 10 μm, between 1.5 μm and 10 μm, between 2 μm and 10 μm, between 5 μm and 10 μm, 0.5 μm and 7 μm, between 0.7 μm and 7 μm, between 0.9 μm and 7 μm, between 1 μm and 7 μm, between 1.2 μm and 7 μm, between 1.5 μm and 7 μm, between 2 μm and 7 μm, between 5 μm and 7 μm, 0.5 μm and μm, between 0.7 μm and 5 μm, between 0.9 μm and 5 μm, between 1 μm and 5 μm, between 1.2 μm and 5 μm, between 1.5 μm and 5 μm, or between 2 μm and 5 μm, including any range therebetween. Each possibility represents a separate embodiment of the invention. As used herein, the term “dry thickness” refers to the thickness of a solid layer (e.g. substantially devoid of solvent). Solid layer refers to a dried coating layer. In some embodiments, solid layer comprises a solvent content of less than 1% (w/w), less than 0.1% (w/w), less than 0.01% (w/w), less than 0.001% (w/w), or less than 0.0001% (w/w), including any range therebetween. Each possibility represents a separate embodiment of the invention.

In some embodiments, the coated substrate comprises at least 2, at least 3, at least 4, at least 5, at least 10, at least 15, at least 20, at least 50, or at least 100 coating layer, including any value therebetween. Each possibility represents a separate embodiment of the invention. In some embodiments, the layers are consecutive layers. In some embodiments, the layers are stacked. In some embodiments, the increase of coating layers increases the thickness of the final coating. It should be understood that a substrate comprising e.g. 2 coating layers is characterized by a dry thickness of 2 individual layers (the double of the dry thickness of a first coating layer as described hereinabove). In some embodiments, the coating layer (e.g. a multi-layer coating) remains its stability and/or optic properties at a thickness up to 100 μm, up to 250 μm, up to 500 μm, up to 700 μm, up to 500 μm, up to 1000 μm, up to 2500 μm, or up to up to 5000 μm, including any value therebetween. Each possibility represents a separate embodiment of the invention.

In some embodiments, the increase of the number of coating layers, increases the ultraviolet (UV) absorbance of the coated substrate. In some embodiments, the increase of the number of coating layers, increases the UV absorbance of the final coating layer. As used herein, the term “ultraviolet” (also referred to as “UV”) refers to the wavelength up to electromagnetic radiation of 400 nm.

In some embodiments, the coated substrate is characterized by an UV absorbance between 60% and 100%, between 65% and 100%, between 70% and 100%, between 80% and 100%, between 90% and 100%, between 95% and 100%, between 60% and 99%, between 65% and 99%, between 70% and 99%, between 80% and 99%, between 90% and 99%, between 95% and 99%, between 60% and 98%, between 65% and 98%, between 70% and 98%, between 80% and 98%, between 90% and 98%, between 95% and 98%, between 60% and 95%, between 65% and 95%, between 70% and 95%, between 80% and 95%, between 90% and 95%, between 60% and 80%, between 65% and 80%, or between 70% and 80%, including any range therebetween, as measured according to ASTM D1003. Each possibility represents a separate embodiment of the invention.

In some embodiments, the coating is configured to reduce UV light intensity (e.g. of the solar light) within a wavelength range of between 100 nm and 400 nm by at least 10%, at least 20%, at least 30%, at least 40%, at least 50%, at least 60%, including any range or value therebetween, as compared to a non-coated substrate. Each possibility represents a separate embodiment of the invention. In some embodiments, the coated substrate reduces UV light intensity (e.g. of the solar light) within a wavelength range of between 100 nm and 400 nm by at least 10%, at least 20%, at least 30%, at least 40%, at least 50%, at least 60%, including any range or value therebetween, as compared to a non-coated substrate. Each possibility represents a separate embodiment of the invention.

In some embodiments, the coating is configured to reduce UV light irradiation absorbed by the substrate by at least 10%, at least 20%, at least 30%, at least 40%, at least 50%, at least 60%, at least 80%, at least 100%, at least 150%, at least 200%, at least 250%, at least 300%, at least 350%, at least 4000%, including any range therebetween, wherein the UV light irradiation is measured at a wavelength ranging between 100 nm and 400 nm as compared to a non-coated substrate. Each possibility represents a separate embodiment of the invention.

In some embodiments, the coating layer further comprises between 0.01% (w/w) and 0.2% (w/w), between 0.05% (w/w) and 0.2% (w/w), between 0.09% (w/w) and 0.2% (w/w), between 0.1% (w/w) and 0.2% (w/w), 0.01% (w/w) and 0.1% (w/w), between 0.05% (w/w) and 0.1% (w/w), or between 0.09% (w/w) and 0.1% (w/w) of a surfactant, including any range therebetween. Each possibility represents a separate embodiment of the invention. In some embodiments, the surfactant is a cationic surfactant. In some embodiments, the surfactant is selected from the group consisting of: cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyidimethylammonium bromide (DEDTAB), decyltrimethylammonium bromide (D10TAB), dodecyltriphenylphosphonium bromide (DTPB), and any combination thereof.

In some embodiments, the coating layer consists of the polymer of the invention and optionally of the surfactant as the functional ingredients. In some embodiments, the coating layer consists essentially of the polymer of the invention and optionally of the surfactant. In some embodiments, at least 80%, at least 82%, at least 85%, at least 90%, at least 95%, at least 98%, or at least 99% of the coating layer consist of the polymer of the invention and optionally of the surfactant, including any value therebetween. Each possibility represents a separate embodiment of the invention. As used herein, the term “consisting essentially of” means that the composition, coating or article may include additional ingredients, but only if the additional ingredients, do not materially alter the basic and novel characteristics of the claimed composition, coating or article.

In some embodiments, the coated substrate is substantially stable (e.g., the coated substrate substantially maintains its structural and/or functional properties, such as stability of the coating layer, absence of disintegration or erosion of the coating layer) for at least one month (m), at least 2 m, at least 6 m, at least 12 m, at least 2 years (y), at least 3 y, at least including any range therebetween, wherein substantially is as described hereinbelow. Each possibility represents a separate embodiment of the invention.

In some embodiments, the coated substrate is substantially stable upon exposure to (i) light radiation, (ii) thermal radiation or a combination of (i) and (ii).

In some embodiments, the thermal radiation comprises a temperature of between and 100° C., between −50 and 0° C., between 0 and 10° C., between 10 and 30° C., between and 50° C., between 50 and 70° C., between 70 and 100° C., including any range therebetween. Each possibility represents a separate embodiment of the invention.

In some embodiments, the light radiation comprises UV and/or visible light radiation. In some embodiments, the coated substrate is stable for at least 12 months, for at least 15 months, for at least 18 months, for at least 20 months, at least 24 months upon exposure to UV radiation of 180 kilo Langley per year (KLy p.a.). In some embodiments, UV stability of the coated substrate is measured according to a well-known stability test (such as ISO 4892-2).

In some embodiments, the coating layer is substantially stable upon exposure to (i) light radiation, (ii) thermal radiation or a combination of (i) and (ii).

In some embodiments, the coating layer is stable at a temperature of between 30 and 100° C., between −50 and 0° C., between 0 and 10° C., between 10 and 30° C., between 30 and 50° C., between 50 and 70° C., between 70 and 100° C., including any range therebetween. Each possibility represents a separate embodiment of the invention.

In some embodiments, the coating layer is stable upon exposure to UV and/or visible light radiation. In some embodiments, the coating layer is stable for at least 12 months, for at least 15 months, for at least 18 months, for at least 20 months, at least 24 months upon exposure to UV radiation of 180 kilo Langley per year (KLy p.a.).

In some embodiments, the term “stable” refers to the ability of the coating layer to substantially maintain its structural, optical, physical and/or chemical properties (e.g. transparency, hardness, UV-absorption).

In some embodiments, the coating layer is referred to as stable, when it is substantially devoid of cracks, deformations or any other surface irregularities.

In some embodiments, the substrate comprises a plurality of hydroxy groups on the outer surface. In some embodiments, the substrate is selected from the group consisting of: a polymeric substrate, a metallic substrate, a paper substrate, a wood substrate, a glass substrate, and any combination thereof.

In some embodiments, the polymeric substrate comprises a polymer selected from the group consisting of: polyethylene (PE), polypropylene (PP), polyethylene terephthalate (PET), PET derivatives, polymethylmethacrylate(PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof. In some embodiments, the glass substrate is selected from a borosilicate-based glass substrate, silicon-based glass substrate, ceramic-based glass substrate, silica/quartz-based glass substrate, aluminosilicate-based glass substrate, or any combination thereof.

In some embodiments, the coating layer is characterized by an ultraviolet (UV) transmission of less than 60%. In some embodiments, the coated substrate is characterized by an ultraviolet (UV) transmission of less than 60%. In some embodiments, the UV transmission can be tuned by choosing different number of layers or different concentrations of the silane-based polymer.

In some embodiments, the coating layer is characterized by an ultraviolet (UV) transmission of less than 60%, less than 50%, less than 20%, less than 10%, less than 5%, less than 4%, or less than 2%, including any value therebetween. Each possibility represents a separate embodiment of the invention. In some embodiments, the coated substrate is characterized by an ultraviolet (UV) transmission of less than 60%, less than 50%, less than 20%, less than 10%, less than 5%, less than 4%, or less than 2%, including any value therebetween. Each possibility represents a separate embodiment of the invention.

In some embodiments, the coating layer is characterized by an ultraviolet (UV) transmission between 10% and 2%, between 9% and 2%, between 8% and 2%, between 7% and 2%, between 4% and 2%, or between 4% and 2%, including any range therebetween. Each possibility represents a separate embodiment of the invention. In some embodiments, a coated substrate comprising one coating layer as described herein, is characterized by an ultraviolet (UV) transmission between 10% and 2%, between 9% and 2%, between 8% and 2%, between 7% and 2%, between 4% and 2%, or between 4% and 2%, including any range therebetween. Each possibility represents a separate embodiment of the invention.

In some embodiments, a coated substrate comprising at least two coating layer as described herein, is characterized by an ultraviolet (UV) transmission between 5% and between 4% and 0.5%, between 3% and 0.5%, between 2% and 0.5%, between 5% and 0.9%, between 4% and 0.9%, between 3% and 0.9%, between 2% and 0.9%, between 5% and 1%, between 4% and 1%, between 3% and 1%, or between 2% and 1%, including any range therebetween. Each possibility represents a separate embodiment of the invention. As used herein “ultraviolet (UV) transmission” refers to a portion of the UV light intensity that transmit through a material.

In some embodiments, the coated substrate is characterized by visible light transmission (VLT) between 80% and 99%, between 82% and 99%, between 85% and 99%, between 89% and 99%, between 90% and 99%, between 95% and 99%, between 80% and 95%, between 82% and 95%, between 85% and 95%, between 89% and 95%, between 90% and 95%, between 80% and 90%, between 82% and 90%, or between 85% and 90%, including any range therebetween. Each possibility represents a separate embodiment of the invention. As used herein “visible light transmission (VLT)” refers to a measurement of the amount of visible light waves that transmit through a material.

In some embodiments, the coating layer is characterized by a haze between 6% and 20%, between 8% and 20%, between 10% and 20%, between 12% and 20%, between 15% and 20%, between 8% and 16%, between 10% and 16%, or between 6% and 10%, including any range therebetween. Each possibility represents a separate embodiment of the invention. In some embodiments, the coated substrate is characterized by a haze between 6% and 20%, between 8% and 20%, between 10% and 20%, between 12% and 20%, between 15% and 20%, between 8% and 16%, between 10% and 16%, or between 6% and 10%, including any range therebetween. Each possibility represents a separate embodiment of the invention. As used herein, “haze” refers to the fraction of light transmission which deviates greater than 2.5°.

In some embodiments, the coated substrate is characterized by a shrinkage between 1% and 40%, between 1% and 35%, between 1% and 30%, between 1% and 25%, between 1% and 20%, 5% and 40%, between 5% and 35%, between 5% and 30%, between 5% and 25%, between 5% and 20%, 10% and 40%, between 10% and 35%, between 10% and 30%, between 10% and 25%, or between 10% and 20%, including any range therebetween, obtained by thermal shrinkage process. Each possibility represents a separate embodiment of the invention. In some embodiments, the coated substrate characterized by a shrinkage between 1% and 40%, is characterized by substantially the same or an improved UV-blocking transmission, when compared to the coated substrate devoid of shrinkage. In some embodiments, improved is by at least 0.01-fold, at least 0.1 fold, at least 0.2 fold, at least 0.5 fold, at least 0.9 fold, at least 1 fold, at least 2 fold, at least 5 fold, at least 10 fold, %, including any value therebetween. Each possibility represents a separate embodiment of the invention. As used herein, “thermal shrinkage” refers to the process of reheating a plastic film or sheet, thereby changing its linear dimension.

In some embodiments, the coating is an elastic coating. In some embodiments, the coating substantially retains (e.g. at least 90%, at least 95% retention, or more) its properties such as physical and/or structural stability, UV-blocking and/or UV-absorbance, upon deformation (e.g. shrinkage up to 30% or more), as compared to the undeformed coating.

### The Coating Composition

According to an aspect of some embodiments of the present invention there is provided a composition (also used herein as “the coating composition”) comprising: (i) a substrate, (ii) a silane-based monomer, wherein the silane-based compound is represented by or comprises Formula I:

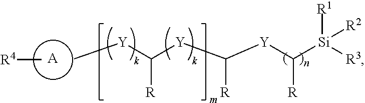

wherein: A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl; each Y independently represents C, CH, CH₂, or O; n is a integer ranging from 1 to 5; each k is a integer ranging from 0 to 5; m is a integer ranging from 0 to 5; each of R¹, R², R³ independently represents hydrogen, or is selected from the group comprising optionally substituted C₁-C₆ alkyl, —O(C₁-C₆ alkyl), or a combination thereof, wherein at least one R′, R² or R³ represents the substituent; and each of R, R⁴ independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; and (iii) a solvent, a surfactant or both. In some embodiments, A comprises a UV absorbing functional group.

In some embodiments, the silane-based polymer is represented by or comprises Formula II:

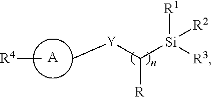

wherein A, Y, R, R², R³, R⁴ and n are as described herein.

In some embodiments, the silane-based polymer is represented by or comprises Formula IIIa: or Formula Mb:

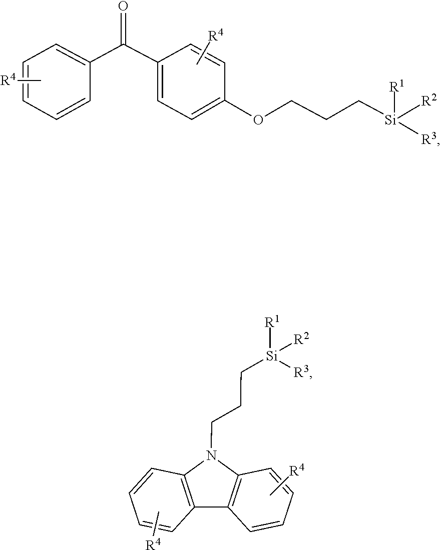

### or Formula Mc:

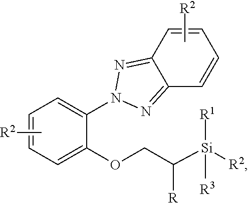

wherein R, R¹, R², R³, and R⁴ are as described herein.

In some embodiments, the silane-based polymer is represented by or comprises any one of:

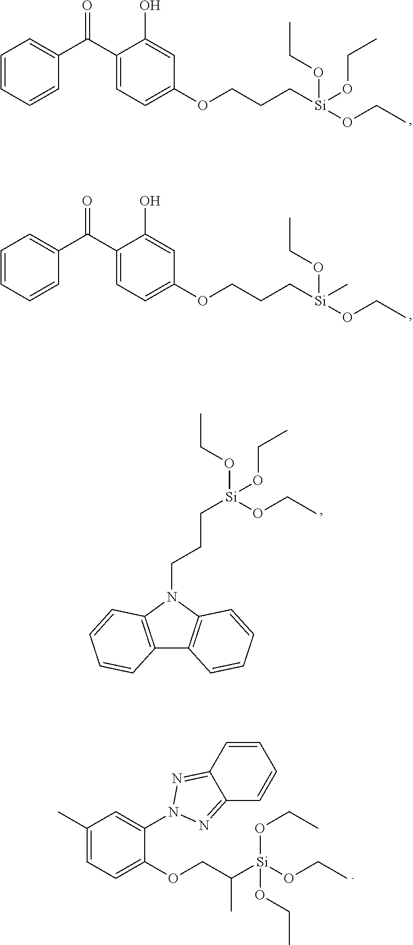

In some embodiments, the silane-based compound is covalently bound to at least a portion of the substrate, forming a coating layer. In some embodiments, the silane-based compound is a silane-based polymer as described hereinabove.

In some embodiments, the coating layer is characterized by a wet thickness between 80 μm and 200 μm, between 90 μm and 200 μm, between 95 μm and 200 μm, between 100 μm and 200 μm, between 120 μm and 200 μm, between 150 μm and 200 μm,

80 μm and 180 μm, between 90 μm and 180 μm, between 95 μm and 180 μm, between 100 μm and 180 μm, between 120 μm and 180 μm, between 150 μm and 180 μm,

80 μm and 180 μm, between 90 μm and 180 μm, between 95 μm and 180 μm, between 100 μm and 180 μm, or between 120 μm and 180 μm, including any range therebetween. Each possibility represents a separate embodiment of the invention.

As used herein, the term “wet thickness” refers to the thickness of a layer formed as measured after adding a liquid composition to the substrate, as described herein.

In some embodiments, the solvent is a protic solvent. In some embodiments, the solvent is a protic solvent selected from the group consisting of: water, ethanol, methyl ethyl ketone, isopropanol, methanol, butanol and any combination thereof.

In some embodiments, the coating layer further comprises between 0.01% (w/w) and 0.2% (w/w), between 0.05% (w/w) and 0.2% (w/w), between 0.09% (w/w) and 0.2% (w/w), between 0.1% (w/w) and 0.2% (w/w), 0.01% (w/w) and 0.1% (w/w), between 0.05% (w/w) and 0.1% (w/w), or between 0.09% (w/w) and 0.1% (w/w) of a surfactant, including any range therebetween. Each possibility represents a separate embodiment of the invention. In some embodiments, the surfactant is a cationic surfactant. In some embodiments, the surfactant is selected from the group consisting of: cetyltrimethylammonium bromide (CTAB), cetyltrimethylammonium chloride (CTACl), tetradecyltrimethylammonium bromide(TTAB), tetradecyltrimethyl ammonium chloride (TTACl), dodecyltrimethylammonium bromide (DTAB), dodecyl trimethylammonium chloride (DTACl), dodecylethyidimethylammonium bromide (DEDTAB), decyltrimethylammonium bromide (D10TAB), dodecyl triphenylphosphonium bromide (DTPB), and any salt or any combination thereof.

In some embodiments, a weight per weight (w/w) concentration of the silane-based polymer in the coating layer is between 0.5% (w/w) and 10% (w/w), between 1% (w/w) and 10% (w/w), between 2% (w/w) and 10% (w/w), between 5% (w/w) and 10% (w/w), between 0.5% (w/w) and 8% (w/w), between 1% (w/w) and 8% (w/w), between 2% (w/w) and 8% (w/w), or between 5% (w/w) and 8% (w/w), including any range therebetween. Each possibility represents a separate embodiment of the invention.

In some embodiments, the herein disclosed composition is characterized by an improved stability, as compared to a reference composition. By “improved stability” it is meant to refer to having a more desirable shelf live or chemical property. In some embodiments, improved stability refers to improved heat resistance, and/or improved moisture resistance. In some embodiments, the composition is characterized by a stability (e.g., shelf life) of at least 2 months, at least 3 months, at least 4 months, at least 5 months, at least 6 months, at least 1 year, at least 2 years, at least 5 years, or at least 10 years including any value therebetween. Each possibility represents a separate embodiment of the invention. In some embodiments, the shelf live is extended by at least 1 day, at least 5 days, at least 10 days, at least 20 days, at least 50 days, at least 2 months, at least 3 months, at least 5 months, or at least 1 year, including any value therebetween. Each possibility represents a separate embodiment of the invention.

In some embodiments, the composition is a liquid coating composition. In some embodiments, the composition is a solid composition. In some embodiments, the composition (e.g. solid composition) is in a form of a film. In some embodiments, the composition (e.g. solid composition) is in a form of a coating layer.

As used herein the term “coating” and any grammatical derivative thereof, is defined as a coating that (i) is positioned above a substrate, (ii-a) it is in contact with the substrate, or (ii-b) is not necessarily in contact with the substrate, that is to say one or more intermediate coatings may be arranged between the substrate and the coating in question, and (iii) does not necessarily completely cover the substrate. In some embodiments, the coating can be applied as single coating layer or as a plurality of coating layers. As used herein throughout, the term “polymer” describes an organic substance composed of a plurality of repeating structural units (backbone units) covalently connected to one another.

### Articles

According to an aspect of some embodiments of the present invention there is provided an article comprising the coated substrate described herein or the composition described herein.

In some embodiments, the coated substrate described herein is or forms a part of an article. Hence according to an aspect of some embodiments of the present invention there is provided an article comprising a coated substrate incorporating in and/or on at least a portion thereof a composition, as described in any one of the respective embodiments herein.

In some embodiments, the article is selected from the group consisting of: transparent plastic surfaces, lenses, a package, and windows. In some embodiments, the article is a construction element, such as, but not limited to, paints, walls, windows, door handles, and the like. In some embodiments, the article according to the invention may be any optical article, such as a screen, a glazing for the automotive industry or the building industry, a mirror, an optical lens, or an ophthalmic lens. Exemplary articles include, but are not limited to, medical devices, organic waste processing device, fluidic device, an agricultural device, a package (e.g., a food packaging), a sealing article, a fuel container, a water and cooling system device and a construction element.

### The Process

According to an aspect of some embodiments of the present invention there is provided a process for coating a substrate, comprising the steps of: (a) providing an at least partially oxidized substrate comprising a plurality of hydroxy groups, and (b) contacting the substrate with the composition described hereinabove, under conditions suitable for the silane-based compound to polymerize and covalently bound to the substrate, thereby forming a coated substrate. In some embodiments, the coated substrate is a coated substrate as described hereinabove.

According to an aspect of some embodiments of the present invention there is provided a process for obtaining a coated substrate, comprising the steps of: (a) providing at least partially oxidized substrate comprising a plurality of hydroxy groups; and (b) contacting the substrate with a composition comprising: (i) a silane-based monomer, wherein the silane-based monomer is represented by or comprises Formula Id:

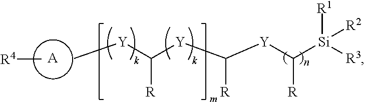

wherein: A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl; each Y independently represents C, CH, CH₂, or O; n is a integer ranging from 1 to 5; each k is a integer ranging from 0 to 5; m is a integer ranging from 0 to 5; each of R¹, R², R³ independently represents hydrogen, or is selected from the group comprising optionally substituted C₁-C₆ alkyl, —O(C₁-C₆ alkyl), —OH, or a combination thereof, wherein at least one R′, R² or R³ represents the substituent; and each of R, R⁴ independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; and (ii) a solvent, a surfactant or both, under conditions suitable for the silane-based monomer to polymerize and covalently bound to the substrate, thereby forming a coating layer on the substrate.

In some embodiments, the silane-based monomer is represented by or comprises Formula II:

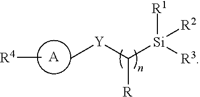

In some embodiments, A comprises a UV absorbing functional group as described herein.

In some embodiments, the process further comprises a step (c) of washing the substrate to remove non-bound silane-based compound.

In some embodiments, contacting is selected from the group comprising: dipping, spraying, spreading, or curing. In some embodiments, the coating can be easily applied in the substrate with the use of a brush, roller, spray, or dipping. In some embodiments, the coating is applied to the substrate by a method selected from the group comprising: spin coating, spray coating, spray and spin coating, curtain coating, flow coating, dip coating, injection molding, casting, roll coating, wire coating, thermal spraying, high velocity oxygen fuel coating, centrifugation coating, spin coating, vapor phase deposition, chemical vapor deposition, physical vapor deposition and any of the methods used in preparing coating layers.

Generally, the application method selected will depend upon, among other things, chemical properties of materials composing the coating, the thickness of the desired coating, the geometry of the substrate to which the coating is applied, and the viscosity of the coating. Other coating methods are well known in the art and some of them may be applied to the present application.

In some embodiments, the method further comprises a step of drying the coated substrate. In some embodiments, drying is performed by convection drying, such as by applying a hot gas stream to a coated substrate. In some embodiments, drying is performed by cold drying, such as by applying a de-humidified gas stream to a coated substrate.

In some embodiments, the method further comprises vacuum drying of the coated substrate.

In some embodiments, the coating layer is characterized by a wet thickness between 80 μm and 200 μm, between 90 μm and 200 μm, between 95 μm and 200 μm, between 100 μm and 200 μm, between 120 μm and 200 μm, between 150 μm and 200 μm,

80 μm and 180 μm, between 90 μm and 180 μm, between 95 μm and 180 μm, between 100 μm and 180 μm, between 120 μm and 180 μm, between 150 μm and 180 μm,

80 μm and 180 μm, between 90 μm and 180 μm, between 95 μm and 180 μm, between 100 μm and 180 μm, or between 120 μm and 180 μm, including any range therebetween. Each possibility represents a separate embodiment of the invention.

In some embodiments, the method further comprises a step of thermal curing the coated substrate at temperature between 40° C. and 200° C., between 50° C. and 200° C., between 60° C. and 200° C., between 70° C. and 200° C., between 40° C. and 100° C., between and 100° C., between 60° C. and 100° C., between 70° C. and 100° C., between 40° C. and between 50° C. and 85° C., between 60° C. and 85° C., or between 70° C. and 85° C., including any range therebetween. Each possibility represents a separate embodiment of the invention.

In some embodiments, the substrate is an at least partially oxidized substrate. In some embodiments, prior to the coating process, the surface of the substrate is treated by methods known in the art, such as, and without being limited thereto, plasma treatment, UV-ozone treatment, or corona discharge.

According to an aspect of some embodiments of the present invention there is provided a process for receiving a UV-blocking composition.

According to an aspect of some embodiments of the present invention there is provided a process for receiving a coated substrate, comprising a substrate and a the silane-based polymer linked to a portion of at least one surface of the substrate, characterized by a water contact angle by an ultraviolet (UV) transmission between 5% and 0.5%, between 4% and 0.5%, between 3% and 0.5%, between 2% and 0.5%, between 5% and 0.9%, between 4% and 0.9%, between 3% and 0.9%, between 2% and 0.9%, between 5% and 1%, between 4% and 1%, between 3% and 1%, or between 2% and 1%, including any range therebetween. Each possibility represents a separate embodiment of the invention.

According to an aspect of some embodiments of the present invention there is provided a process for receiving a coated substrate, comprising a substrate and a the silane-based polymer linked to a portion of at least one surface of the substrate, characterized by visible light transmission (VLT) between 80% and 99%, between 82% and 99%, between 85% and 99%, between 89% and 99%, between 90% and 99%, between 95% and 99%, between 80% and 95%, between 82% and 95%, between 85% and 95%, between 89% and 95%, between 90% and 95%, between 80% and 90%, between 82% and 90%, or between 85% and 90%, including any range therebetween. Each possibility represents a separate embodiment of the invention.

According to an aspect of some embodiments of the present invention there is provided a process for receiving a coated substrate, comprising a substrate and the silane-based polymer linked to a portion of at least one surface of the substrate, characterized by a haze between 6% and 20%, between 8% and 20%, between 10% and 20%, between 12% and 20%, between 15% and 20%, between 8% and 16%, between 10% and 16%, or between 6% and 10%, including any range therebetween. Each possibility represents a separate embodiment of the invention.

As used herein, the term “silane” refers to monomeric silicon compounds with four substituents, or groups, attached to the silicon atom. These groups can be the same or different and nonreactive or reactive, with the reactivity being inorganic or organic.

By “silane derivative” or “silane coupling agent” is meant a silane having at least one chemical moiety that does participate in polymerization of the silane. This chemical moiety may have a reactive functional group to attach other chemical species to the silane monomer or polymer, e.g., organic molecules.

As used herein, “crosslinked” and/or “crosslinking”, and any grammatical derivative thereof refers generally to a chemical process or the corresponding product thereof in which two chains of polymeric molecules are attached by bridges (crosslinker) composed of an element, a group or a compound, which join certain carbon atoms of the chains by primary chemical.

In some embodiments, when applied on the substrate, the coating layer does not alter the external appearance of the substrate (e.g. transparent coating). In some embodiments, the coating layer is transparent. In some embodiments, the coating layer is a solid. In some embodiments, the terms “coating layer” and “coating” are used herein interchangeably.

In some embodiments, the substrate is at least partially hydrophobic substrate. In some embodiments, the substrate is a hydrophobic substrate. In some embodiments, the substrate is at least partially hydrophilic. In some embodiments, the substrate is a hydrophilic substrate. In some embodiments, the substrate is at least partially oxidized.

Substrate usable according to some embodiments of the present invention can have, for example, organic or inorganic surfaces, including, but not limited to, glass surfaces; porcelain surfaces; ceramic surfaces; silicon or organosilicon surfaces, metallic surfaces (e.g., stainless steel); polymeric surfaces such as, for example, plastic surfaces, rubbery surfaces, paper; wood; fabric in a woven, knitted or non-woven form; mineral (rock or glass), surfaces, wool, silk, cotton, hemp, leather, fur, feather, skin, hide, pelt or pelage surfaces, plastic surfaces and surfaces comprising or made of polymers, nylons, inorganic polymers such as silicon rubber or glass; or can comprise or be made of any of the foregoing substances, or any mixture thereof. The substrate may be any number of substrates, porous, and non-porous substrates. By non-porous it is meant that a substrate does not have pores sufficient to significantly increase the bonding of the coating to the unprimed substrate. Non-porous substrates are selected from but are not limited to polymers of polycarbonate, polyesters, nylons, and metallic foils such as aluminum foil, with nylons and metallic foils.

In some embodiments, the substrate comprises a glass substrate. Non-limiting examples of glass substrates according to the present invention comprise: borosilicate-based glass substrate, silicon-based glass substrate, ceramic-based glass substrate, silica/quartz-based glass substrate, aluminosilicate-based glass substrate, or any combination thereof.

In some embodiments, the substrate comprises a polymeric substrate. In some embodiments, the polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

In some embodiments, the substrate is a metal substrate. In some embodiments, the metal substrate is further coated with a paint and/or lacquer.

Substrate usable according to some embodiments of the present invention can therefore be hard (rigid) or soft, solid, semi-solid, or liquid substrates, and may take a form of a foam, a solution, an emulsion, a lotion, a gel, a cream or any mixture thereof.

Substrates of widely different chemical nature can be successfully utilized for incorporating the disclosed composition and coating layers, as described herein. By “successfully utilized” it is meant that (i) the disclosed composition and coating layers, successfully form a uniform and homogenously coating on the substrate's surface; and (ii) the resulting coating imparts long-lasting desired properties to the substrate's surface. In some embodiments, the substrate is further coated with a lacquer, a varnish or a paint.

In some embodiments, the disclosed composition and coating layer form a layer thereof in/on a surface the substrate. In some embodiments, the coating layer represent a surface coverage referred to as “layer” e.g., 100%. In some embodiments, the coating layer represents about 90%, about 80%, about 70%, about 60%, about 50%, about 40%, of surface coverage, including any value therebetween. In some embodiments, the substrate further comprises a plurality of coating layers.

In some embodiments, the coating layer is homogenized deposited on a surface.

In some embodiments, the composition or the coating layer in a solution comprising solvent as described herein. In some embodiments, the solution is devoid of a curing agent, a surfactant, or a stabilizer.

In some embodiments, the resulting coated substrates are air-dried. In some embodiments, the coating process further comprises a step of evaporating the solvent(s) mixture or coating (e.g., the mixture or coating deposited on the substrate). The step of evaporating the solvent(s) may be performed at e.g., room temperature (i.e. 15° C. to 30° C.) or at elevated temperature (i.e. up to 100° C.).

According to an aspect of some embodiments of the present invention there is provided a coated substrate, obtained by the process described hereinabove. In some embodiments, the coated substrate comprises a substrate, and a silane-based polymer.

In some embodiments, there is provided a coated substrate, obtained by the process described hereinabove, wherein the coated substrate comprises a substrate, and a silane-based polymer, wherein: i) the silane-based polymer is covalently bound to at least a portion of the substrate, forming a coating layer, and ii) the silane-based polymer is represented by or comprises Formula Ie:

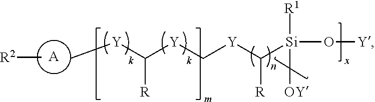

wherein: Y′ and x are as described herein, wherein A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl; each Y independently represents C, CH, CH₂ or O; n is a integer ranging from 1 to 5; each k is a integer ranging from 0 to 5; m is a integer ranging from 0 to 5; R¹ represents hydrogen, or is selected from the group comprising optionally substituted C₁-C₆ alkyl, —O(C₁-C₆ alkyl), —OH, or a combination thereof; and each of R and R² independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; and at least one represents a covalent bond to the substrate.

### Anti-Fogging and Superhydrophobic Coatings

According to some embodiments, the present invention provides a coated substrate comprising a substrate and mesoporous SiO₂-coating, wherein the mesoporous SiO₂-coating is covalently bound to at least a portion of the substrate, forming a first coating layer. In some embodiments, the first coating layer is a hydrophilic coating layer. In some embodiments, the coated substrate is characterized by a water contact angle on the surface of the first coating layer of less than 40°.

In some embodiments, the coated substrate further comprises a second coating layer, comprising a hydrophobic agent. In some embodiments, the coated substrate is characterized by a water contact angle on the surface of the second coating layer of at least 130°.

The present invention is based, in part, on the finding that coated substrates comprising mesoporous SiO₂-coating are characterized by improved anti-fogging properties and superhydrophobic properties compared to an equivalent substrate coated with SiO₂-coating.

### Coated Substrates

According to an aspect of some embodiments of the present invention there is provided a coated substrate comprising a substrate and mesoporous SiO₂-coating. According to an aspect of some embodiments of the present invention there is provided a coated substrate comprising a substrate and mesoporous SiO₂-coating, wherein: i) the mesoporous SiO₂-coating is covalently bound to at least a portion of the substrate, forming a first coating layer; ii) the first coating layer is characterized by a dry thickness between μm and 10 μm; and iii) the first coating layer is characterized by a roughness between 1 nm and 100 nm, as measured by Atomic Force Microscope (AFM). In some embodiments, the first coating layer is characterized by a roughness between 1 nm and 200 nm, between nm and 200 nm, between 10 nm and 200 nm, between 25 nm and 200 nm, between 45 nm and 200 nm, between 50 nm and 200 nm, between 70 nm and 200 nm, between 90 nm and 200 nm, between 45 nm and 130 nm, between 50 nm and 130 nm, between 70 nm and 130 nm, between 90 nm and 130 nm, between 1 nm and 100 nm, between 5 nm and 100 nm, between 10 nm and 100 nm, between 25 nm and 100 nm, between 45 nm and 100 nm, between 50 nm and 100 nm, between 1 nm and 80 nm, or between 5 nm and 80 nm, as measured by AFM, including any range therebetween. Each possibility represents a separate embodiment of the invention.

In some embodiments, the mesoporous SiO₂-coating is characterized by a pore size between 2 nm and 50 nm, between 4 nm and 50 nm, between 5 nm and 50 nm, between nm and 50 nm, between 12 nm and 50 nm, between 2 nm and 40 nm, between 4 nm and nm, between 5 nm and 40 nm, between 10 nm and 40 nm, between 12 nm and 40 nm, between 2 nm and 25 nm, between 4 nm and 25 nm, between 5 nm and 25 nm, between 10 nm and 25 nm, or between 12 nm and 25 nm, including any range therebetween. Each possibility represents a separate embodiment of the invention. As used herein, the terms “pore” and “porous” refer to an opening or depression in the surface of a mesoporous SiO₂-coating or coating layer.

In some embodiments, the mesoporous SiO₂-coating is a porous silica-based matrix comprising amorphous polysiloxane. In some embodiments, the matrix is in a form of a mesh comprising interconnected (via covalent Si—O bonds) polysiloxane. In some embodiments, the polysiloxane is characterized by a repeating unit of

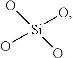

also assigned as SiO₂.

In some embodiments, the matrix further comprises an additional polysiloxane. In some embodiments, the additional polysiloxane is physically and/or covalently bound to the silica chains. In some embodiments, the matrix comprises a plurality of chemically distinct polysiloxane species bound via a covalent and/or a non-covalent bond.

In some embodiments, the additional polysiloxane is a copolymer. In some embodiments, the additional polysiloxane is a graft-copolymer or a block-copolymer. In some embodiments, the additional polysiloxane is or comprises a polysiloxane backbone modified with a hydrophobic polymer, such as polyalkoxylate (e.g. PEG, optionally comprising a terminal hydroxy and/or amino group). In some embodiments, the additional polysiloxane is or comprises a PEG-ylated silica or a PEG-ylated polysiloxane. In some embodiments, the additional polysiloxane is or comprises a PEG-ylated polysiloxane graft co-polymer.

In some embodiments, the porous matrix further comprises a surfactant, and optionally a stabilizer incorporated (or physically bound) on top and/or within the matrix, as described herein. In some embodiments, the surfactant is incorporated within the matrix, and is bound to the polysiloxane. In some embodiments, the surfactant stabilizes the micelles within the coating composition and induces pore formation. In some embodiments, the surfactant stabilizes the porous structure of the mesoporous silica coating.

In some embodiments, the stabilizer provides or enhances heat sealing capabilities of the mesoporous silica coating.

In some embodiments, a weight ratio between silica and the stabilizer (e.g. PEG, PVP, or both) within the mesoporous silica coating is between 20:1 and 1:1, between 20:1 and 15:1, between 15:1 and 10:1, between 10:1 and 8:1, between 8:1 and 5:1, between 5:1 and 3:1, between 3:1 and 1:1, including any range between.

In some embodiments, a weight ratio between silica and the additional polysiloxane within the mesoporous silica coating is between 5:1 and 1:5, 5:1 and 3:1, 3:1 and 1:1, 1:1 and 1:3, 1:3 and 1:5, including any range between.

In some embodiments, a weight ratio between silica and the surfactant within the mesoporous silica coating is between 10:1 and 1:1, between 10:1 and 5:1, between 5:1 and 3:1, between 3:1 and 1:1, including any range between.

In some embodiments, the mesoporous SiO₂-coating comprises mesoporous SiO₂ microparticles. In some embodiments, the mesoporous SiO₂-coating comprises mesoporous SiO₂ nanoparticles. In some embodiments, the mesoporous SiO₂-coating comprises mesoporous SiO₂ microparticles, and mesoporous SiO₂ nanoparticles. In some embodiments, the mesoporous SiO₂-coating comprises mesoporous SiO₂ aggregates. In some embodiments, the mesoporous SiO₂ microparticles, mesoporous SiO₂ nanoparticles, and mesoporous SiO₂ aggregates result from a modified Stöber polymerization process of TEOS in presence of a surfactant as described herein. In some embodiments, the surfactant causes the mesoporous SiO₂ particles to aggregate (see, Example 2).

The term “silica” and the term “SiO₂” are used herein interchangeably.

In some embodiments, the mesoporous SiO₂-coating comprises particles, aggregates, and bulks of mesoporous SiO₂. In some embodiments, the mesoporous SiO₂-coating is in the form of flakes. It should be understood that bulk, aggregate and flakes refers to non-limiting examples of agglomerates of mesoporous SiO₂ characterized by different sizes and shapes.

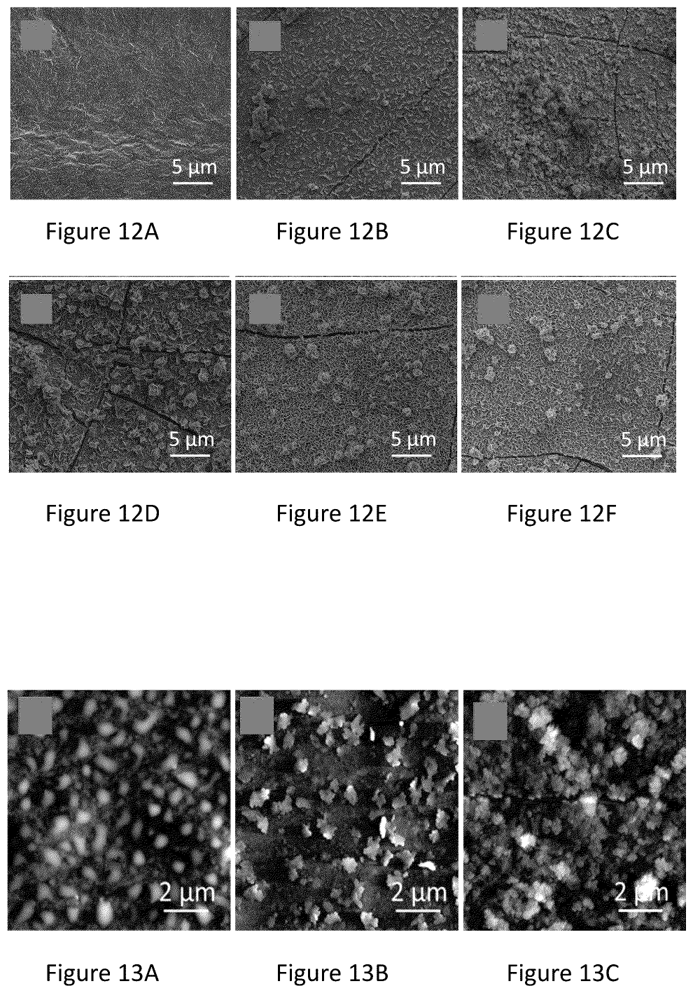

In some embodiments, the mesoporous SiO₂-coating is characterized by hierarchical topography. In some embodiments, the mesoporous SiO₂-coating is characterized by hierarchical porosity. In some embodiments, a coated substrate comprising a mesoporous SiO₂-coating characterized by hierarchical topography and/or hierarchical porosity, is characterized by a micro roughness and/or micro roughness (see, FIGS. 12A-F and FIGS. 13A-C).

As used herein, the terms “hierarchically porous” and “hierarchical porosity” refer to the presence of at least two different pore sizes in the coating. The different pores may be arranged, with respect to each other, in any of several different ways. In some embodiments, at least one (or both, or all) of the mesopores are arranged in an ordered (i.e., patterned) manner. As used herein, the terms “hierarchical topography” refers to the presence of at least two different shapes/sizes of mesoporous SiO₂ in the coating. The different mesoporous SiO₂ particles may be arranged, with respect to each other, in any of several different ways. In other embodiments, at least one (or both, or all) of the mesoporous SiO₂ are arranged in an ordered (i.e., patterned) manner.

In some embodiments, the mesoporous SiO₂-coating is in the form of a particle/aggregate as described herein. In some embodiments, the mesoporous SiO₂-based particles are aggregated. In some embodiments, the mesoporous SiO₂-based particles are in the form of agglomerated particles. In some embodiments, the particle comprises a plurality of pores (i.e. a space or lumen). In some embodiments, the mesoporous SiO₂-based particles are characterized by a pore size between 2 nm and 50 nm, between 4 nm and 50 nm, between nm and 50 nm, between 10 nm and 50 nm, between 12 nm and 50 nm, between 2 nm and nm, between 4 nm and 40 nm, between 5 nm and 40 nm, between 10 nm and 40 nm, between 12 nm and 40 nm, between 2 nm and 25 nm, between 4 nm and 25 nm, between 5 nm and 25 nm, between 10 nm and 25 nm, or between 12 nm and 25 nm, including any range therebetween. Each possibility represents a separate embodiment of the invention.

In some embodiments, the first coating layer is characterized by a porosity of at least 5%, at least 10%, at least 30%, at least 50%, or at least 60%, including any value therebetween. Herein, the term “porosity” refers to a percentage of the volume of a substance which consists of voids. In some embodiments, porosity is measured according to voids within the surface area divided to the entire surface area (porous and non-porous).

In some embodiments, the mesoporous SiO₂-based particles are characterized by a median size between 5 nm and 150 nm, between 10 nm and 150 nm, between 20 nm and 150 nm, between 50 nm and 150 nm, between 80 nm and 150 nm, between 100 nm and 150 nm, between 5 nm and 120 nm, between 10 nm and 120 nm, between 20 nm and 120 nm, between 50 nm and 120 nm, between 80 nm and 120 nm, between 100 nm and 120 nm, between 5 nm and 100 nm, between 10 nm and 100 nm, between 20 nm and 100 nm, between 50 nm and 100 nm, or between 80 nm and 100 nm, including any range therebetween. Each possibility represents a separate embodiment of the invention.

In some embodiments, the SiO₂-coating comprises an amorphous polysiloxane represented by or comprising the formula SiO₂, SiO₂—R, and any combination thereof, wherein R is (CH₂)ₙX, n=1 to 30, and X is a functional group selected from activated double bond, amine, PEG, urea, thiourea, melamine, hydantoin, thiol, carboxylate, azide, nitroso, carbonyl, and carboxy.

In some embodiments, the SiO₂-based particle is represented by or comprises the formula SiO₂, SiO₂—R, and any combination thereof, wherein R is (CH₂)ₙX, n=1 to 30, and X is a functional group selected from activated double bond, amine, PEG, urea, thiourea, melamine, hydantoin, thiol, carboxylate, azide, nitroso, carbonyl, and carboxy.

In some embodiments, the first coating layer is characterized by a thickness between 1 nm to 450 nm, between 2 nm to 450 nm, between 5 nm to 450 nm, between 10 nm to 450 nm, between 50 nm to 450 nm, between 100 nm to 450 nm, between 200 nm to 450 nm, between 1 nm to 250 nm, between 2 nm to 250 nm, between 5 nm to 250 nm, between 10 nm to 250 nm, between 50 nm to 250 nm, between 100 nm to 250 nm, between 1 nm to 150 nm, between 2 nm to 150 nm, between 5 nm to 150 nm, between 10 nm to 150 nm, between 50 nm to 150 nm, or between 100 nm to 150 nm, including any range therebetween. Each possibility represents a separate embodiment of the invention.

In some embodiments, the substrate is selected from the group consisting of: a polymeric substrate, a metallic substrate, a paper substrate, a wood substrate, a glass substrate, and any combination thereof. In some embodiments, the glass substrate is selected from a borosilicate-based glass substrate, silicon-based glass substrate, ceramic-based glass substrate, silica/quartz-based glass substrate, aluminosilicate-based glass substrate, or any combination thereof. In some embodiments, the polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

In some embodiments, the coated substrate is characterized by a water contact angle on the surface of the first coating layer of less than 70°, less than 68°, less than 65°, less than 50°, less than 40°, less than 30°, less than 20°, less than 10°, or less than 5°, including any value therebetween. Each possibility represents a separate embodiment of the invention.

In some embodiments, the coated substrate is characterized by a water contact angle on the surface of the first coating layer between 70° and 1°, between 50° and 1°, between 40° and 1°, between 30° and 1°, 70° and 2°, between 50° and 2°, between 40° and 2°, between 30° and 2°, 70° and 5°, between 50° and 5°, between 40° and 5°, or between 30° and 5°, including any range therebetween. Each possibility represents a separate embodiment of the invention.

In some embodiments, the present invention provides a coated substrate with anti-fogging properties.

The term “anti-fog”, and the like are used herein to indicate a composition or a compound that is capable of providing antifogging properties on at least one portion thereof. In the context of the disclosed polymeric particles deposited on or incorporated within a substrate, this term is meant to refer to the antifogging properties being imparted on at least one surface of the substrate. Antifogging properties may be characterized by e.g., roughness, contact angle, haze and gloss or by a combination thereof.

By “antifogging properties” it is meant to refer, inter alia, to the capability of a substrate's surface to prevent water vapor from condensing onto its surface in the form of small water drops redistributing them in the form of a continuous film of water in a very thin layer.

The term “roughness” as used herein relates to the irregularities in the surface texture. Irregularities are the peaks and valleys of a surface.

In some embodiments of the invention, the composition or article disclosed herein exhibit an increased antifogging effect with time.

In some embodiments, the degree of the antifogging property is correlated with the wettability of a surface. Wettability of a surface is typically and acceptably determined by contact angle measurements of aqueous liquids, as is further detailed in the Example section herein below.

Herein, substrate's surface is considered wettable when it exhibits a static contact angle e.g., on the surface of the first layer of less than e.g., 70°, 60°, 50°, 40°, 30°, 20°, 10°, 9°, 8°, 7°, 6°, or 5°, with an aqueous liquid. Each possibility represents a separate embodiment of the invention.

In some embodiments, the coated substrate further comprise a second coating layer, comprising a hydrophobic agent. In some embodiments, the hydrophobic agent is selected from 1H,1H,2H,2H-perfluorododecyl trichlorosilane (FTS), octadecyl trichlorosilane (OTS), 1H,1H,2H,2H-perfluorodecyl triethoxysilane (FTES), octadecyl triethoxysilane (OTES), and any combination thereof.

In some embodiments, the hydrophobic agent is covalently bound to the mesoporous SiO₂, or to the first coating layer. In some embodiments, the hydrophobic agent is covalently bound to the mesoporous SiO₂-coating.

In some embodiments one or more hydrophobic agents are covalently linked to the disclosed particles (of the first “coating layer”) forming a “second layer” or “second coating layer”.

In some embodiments, a coated substrate as described herein comprises a second layer. In some embodiments, a coated substrate as described herein comprises a second layer comprising one or more coupling agents, one or more hydrophobic agents, or a combination thereof. The hydrophobic agents include, without being limited thereto, Silicon-based hydrophobic agents such as siloxane, silane, silicone or a combination thereof; Fluorine-based hydrophobic agents such as fluorosilane, uridoalkylsilane, fluoroalkylsilane (FAS), polytetrafluoroethylene (PTFE), polytrifluoroethylene, polyvinyl fluoride, or functional fluoroalkyl compounds or a combination thereof; Carbohydrate hydrophobic agents or hydrocarbon hydrophobic agents such as reactive wax, polyethylene, polypropylene, or a combination thereof. In some embodiments, the hydrophobic agents include, a functional silane compound polymerized on the first layer. In some embodiments, a functional silane compound refers to a silane containing activated double bond/s, urea functionality or amide functionality. In some embodiments, the second layer comprises SiO₂—R, wherein R is (CH₂)ₙX, n=1 to 30, and X is a functional group selected from activated double bond, amine, urea, thiourea, melamine, hydantoin, thiol, carboxylate, azide, nitroso, carbonyl, and carboxy.

In some embodiments, a coated substrate according to the present invention comprising a second layer is characterized by a water contact angle on the surface of the second layer of at least 130°. In some embodiments, the contact angle is in the range of 130° to 165°. In some embodiments, the composition is characterized by a water contact angle in the range of 130° to 160°, 140° to 165°, or 150° to 165°, including any range therebetween. Each possibility represents a separate embodiment of the invention.

In some embodiments, the coated substrate is characterized by a water contact angle on the surface of the second coating layer between 130° and 180°, between 130° and 168°, between 130° and 165°, between 130° and 160°, between 140° and 180°, between 150° and 168°, including any range therebetween. Each possibility represents a separate embodiment of the invention.

In some embodiments, a coated substrate as described hereinabove comprising a second layer is a superhydrophobic substrate. In some embodiments, a coated substrate as described hereinabove comprising a second layer is characterized by a superhydrophobic surface.

The term “hydrophobic surface” is one that results in a water droplet forming a surface contact angle exceeding about 90° and less than about 150° at room temperature (about 18 to about 23° C.). The term “superhydrophobic surface” is defined as surfaces which have a water contact angle above 150° but less than the theoretical maximum contact angle of about 180° at room temperature. In nature, lotus leaves are considered super hydrophobic. Water drops roll off the leaves collecting dirt along the way to give a “self-cleaning” surface.

In some embodiments of the invention, the coated substrate, the composition or the article disclosed herein exhibits a contact angle on the surface of the second layer of at least 130°, 140°, 150°, 160°, 165° with an aqueous liquid, or any value therebetween.

In some embodiments, the coated substrate is characterized by a roughness between 70 nm and 150 nm, between 80 nm and 150 nm, between 90 nm and 150 nm, between 100 nm and 150 nm, between 70 nm and 120 nm, between 80 nm and 120 nm, between 90 nm and 120 nm, or between 100 nm and 120 nm, including any range therebetween, as measured by Atomic Force Microscope (AFM). Each possibility represents a separate embodiment of the invention.

In some embodiments, the coated substrate is characterized by a haze between 8.5% and 20%, between 9% and 20%, between 9.5% and 20%, between 10% and 20%, between 15% and 20%, between 8.5% and 18%, between 9% and 18%, between 9.5% and 18%, or between 10% and 18%, including any range therebetween. Each possibility represents a separate embodiment of the invention.

In some embodiments, the coated substrate is characterized by a gloss between 25% and 49%, between 30% and 49%, between 35% and 49%, between 40% and 49%, between 25% and 47%, between 30% and 47%, between 35% and 47%, between 40% and 47%, between 25% and 40%, between 30% and 40%, or between 35% and 40%, including any range therebetween. Each possibility represents a separate embodiment of the invention.

In some embodiments, a particle as described herein is a nanoparticle. In some embodiments, a particle as described herein is a microparticle.

Herein throughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s). The term “microparticle” as used herein refers to a particle featuring a size of at least one dimension thereof (e.g., diameter, length) that ranges from about 1 micrometer to 100 micrometers.

In some embodiments, the size of the particles described herein represents an average or median size of a plurality of nanoparticles and/or microparticles. In some embodiments, a plurality of the particles has a uniform size. By “uniform” or “homogenous” it is meant to refer to size distribution that varies within a range of less than e.g., ±60%, ±50%, ±40%, ±30%, ±20%, or ±10%, including any value therebetween. As used herein the terms “average” or “median” size refer to diameter of the polymeric particles. The term “diameter” is art-recognized and is used herein to refer to either of the physical diameter (also termed “dry diameter”) or the hydrodynamic diameter. As used herein, the “hydrodynamic diameter” refers to a size determination for the composition in solution (e.g., aqueous solution) using any technique known in the art, e.g., dynamic light scattering (DLS). As exemplified in the Example section that follows, the dry diameter of the particles, as prepared according to some embodiments of the invention, may be evaluated using transmission electron microscopy (TEM) or scanning electron microscopy (SEM) imaging. The particle(s) can be generally shaped as a sphere, incomplete-sphere, particularly the size attached to the substrate, a rod, a cylinder, a ribbon, a sponge, and any other shape, or can be in a form of a cluster of any of these shapes, or can comprises a mixture of one or more shapes.

In some embodiments, the coating and/or the substrate in contact therewith is a thermal adhesive. In some embodiments, the coating is a heat sealant. In some embodiments, a plurality of coating surfaces have adhesiveness to each other when heated to an appropriate temperature. In some embodiments, the coating is a thermal adhesive, having adhesiveness to a substrate (e.g. a glass substrate and/or a polymeric substrate).

In some embodiments, the coating surface is heat sealable (e.g. a plurality of surfaces adhere to each other or to a substrate), upon heating thereof to an appropriate temperature.

In some embodiments, the composition and/or coating of the invention is thermally curable (e.g. upon heating to an appropriate temperature). In some embodiments, the appropriate temperature is between 70 and 200° C., between 100 and 150° C., between 150 and 200° C., between 70 and 80° C., between 80 and 90° C., between 90 and 100° C., or about 160-190° C., including any range between. In some embodiments, the composition and/or coating of the invention is a thermal adhesive.

In some embodiments, the thermally curable composition and/or coating of the invention comprises the mesoporous silica matrix, and further comprises the stabilizer and/or the additional polysiloxane, wherein the stabilizer and the additional polysiloxane are as described herein.

In some embodiments, the composition has adhesiveness to a substrate (glass substrate, a coated substrate of the invention, a polymeric substrate. In some embodiments, the composition is for use as a thermally curable adhesive for adhesion or sealing of one or more substrate surfaces.

### The Composition

According to an aspect of some embodiments of the present invention there is provided a composition comprising i. a substrate, ii. a silane compound represented by the formula Si(OR)₄, Si(R′)ₙ(OR)₄₋ₙ or a combination thereof, wherein R and R′ are each independently selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; and iii. a surfactant, wherein a weight per weight (w/w) ratio of the silane compound and the surfactant is between 10:1 (w/w) to 40:1 (w/w).

In some embodiments, the silane compound is in the form of mesoporous SiO₂-coating. In some embodiments, the silane compound is in the form of mesoporous SiO₂-based particles are characterized by a median size between 1 nm and 100000 nm. In some embodiments, the mesoporous SiO₂-based particles are the particles described hereinabove.

In some embodiments, the mesoporous SiO₂-coating is covalently bound to at least a portion of the substrate, forming a coating layer.

In some embodiments, the coating layer is characterized by a wet thickness between 2 μm and 20 μm, between 3 μm and 20 μm, between 5 μm and 20 μm, between 7 μm and 20 μm, between 10 μm and 20 μm, between 2 μm and 15 μm, between 3 μm and 15 μm, between 5 μm and 15 μm, between 7 μm and 15 μm, between 2 μm and 10 μm, between 3 μm and 10 μm, between 5 μm and 10 μm, or between 7 μm and 10 μm, including any range therebetween. Each possibility represents a separate embodiment of the invention.

In some embodiments, the mesoporous SiO₂-based particles are characterized by a median size between 1 nm and 100000 nm, between 1 nm and 100000 nm, between 10 nm and 100000 nm, between 100 nm and 100000 nm, between 1000 nm and 100000 nm, or between 10000 nm and 100000 nm, including any range therebetween. Each possibility represents a separate embodiment of the invention.

In some embodiments, the surfactant is as described hereinabove. In some embodiments, the surfactant is selected from the group consisting of: cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyidimethylammonium bromide (DEDTAB), decyltrimethylammonium bromide (D10TAB), dodecyltriphenylphosphonium bromide (DTPB), or any combination thereof.

In some embodiments, the composition comprises a protic solvent. In some embodiments, the composition comprises a protic solvent selected from the group consisting of: water, ethanol, methyl ethyl ketone, isopropanol, methanol, butanol and any combination thereof. In some embodiments, the composition comprises water and ethanol. In some embodiments, the composition comprises water and ethanol at a ratio between 1:2 and 1:10, between 1:3 and 1:10, between 1:5 and 1:10, between 1:7 and 1:10, between 1:2 and 1:7, between 1:3 and 1:7, or between 1:5 and 1:7, including any range therebetween. Each possibility represents a separate embodiment of the invention.

In some embodiments, the composition comprises a base. In some embodiments, the composition comprises between 5 mM and 40 mM, between 7 mM and 40 mM, between mM and 40 mM, between 15 mM and 40 mM, between 20 mM and 40 mM, between 5 mM and 15 mM, between 7 mM and 15 mM, or between 10 mM and 15 mM, of a base, including any range therebetween. Each possibility represents a separate embodiment of the invention. In some embodiments, the base is selected from NH₄OH, KOH, NaOH, or a combination thereof.

In some embodiments, the composition comprises between 0.01% weight per volume (w/v) and 5% (w/v), between 0.05% (w/v) and 5% (w/v), between 0.09% (w/v) and 5% (w/v), between 0.1% (w/v) and 5% (w/v), between 0.5% (w/v) and 5% (w/v), between 1% (w/v) and 5% (w/v), between 2% (w/v) and 5% (w/v), 0.01% weight per volume (w/v) and 1% (w/v), between 0.05% (w/v) and 1% (w/v), between 0.09% (w/v) and 1% (w/v), between 0.1% (w/v) and 1% (w/v), or between 0.5% (w/v) and 1% (w/v) of the surfactant, including any range therebetween. Each possibility represents a separate embodiment of the invention.

In some embodiments, the composition comprises between 50 mM and 80 mM, between 55 mM and 80 mM, between 60 mM and 80 mM, between 50 mM and 70 mM, between 55 mM and 70 mM, or between 60 mM and 70 mM, of the silane compound, including any range therebetween. Each possibility represents a separate embodiment of the invention.

In some embodiments, the substrate is selected from the group consisting of: a polymeric substrate, a metallic substrate, a paper substrate, a wood substrate, a glass substrate, and any combination thereof. In some embodiments, the glass substrate is selected from a borosilicate-based glass substrate, silicon-based glass substrate, ceramic-based glass substrate, silica/quartz-based glass substrate, aluminosilicate-based glass substrate, or any combination thereof. In some embodiments, the polymeric substrate comprises a polymer selected from the group consisting of: polyethylene (PE), polypropylene (PP), polyethylene terephthalate (PET), PET derivatives, polymethylmethacrylate(PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

In some embodiments, the composition is devoid of a curing agent.

In some embodiments, the composition further comprises a hydrophobic agent selected from 1H,1H,2H,2H-perfluorododecyl trichlorosilane (FTS), octadecyl trichlorosilane (OTS), 1H,1H,2H,2H-perfluorodecyl triethoxysilane (FTES), octadecyl triethoxysilane (OTES), and any combination thereof. In some embodiments, the hydrophobic agent is covalently bound to the mesoporous SiO₂-based particles.

In some embodiments, the composition further comprises a silane coupling agent selected from the group consisting of: 3-(Methacryloyloxy)propyl]trimethoxysilane (MPS), 3-(aminooxy)propyl]trimethoxy silane (APS), uridopropyltrimethoxysilane, trialkylpropypylmelaminesilane, triethoxysilylpropyl hydantoin and any combination thereof.

In some embodiments, the composition further comprises a polymer (or a stabilizer) selected from the group consisting of: polyethyleneglycol diacrylate (PEGDA), polyvinylpyrrolidone (PVP), polyethylene glycol (PEG) or any combination thereof.

In some embodiments, a weight ratio between silica and the stabilizer (e.g. PEG, PVP, or both) within the composition is between 20:1 and 1:1, between 20:1 and 15:1, between 15:1 and 10:1, between 10:1 and 8:1, between 8:1 and 5:1, between 5:1 and 3:1, between 3:1 and 1:1, including any range between.

In some embodiments, a weight ratio between silica and the additional polysiloxane within the composition is between 5:1 and 1:5, 5:1 and 3:1, 3:1 and 1:1, 1:1 and 1:3, 1:3 and 1:5, including any range between.

In some embodiments, a weight ratio between silica and the surfactant within the composition is between 10:1 and 1:1, between 10:1 and 5:1, between 5:1 and 3:1, between 3:1 and 1:1, including any range between.

In some embodiments, the composition is for use as anti-fogging coating, superhydrophobic coating, anti-scratch coating, sterilization coating, photochromic coating, self-cleaning coating, anti-microbial coating, anti-fouling coating, or soil solar disinfection coating.

### Articles

According to an aspect of some embodiments of the present invention there is provided an article comprising the coated substrate described herein or the composition described herein.

In some embodiments, the coated substrate described herein is or forms a part of an article. Hence according to an aspect of some embodiments of the present invention there is provided an article comprising a coated substrate incorporating in and/or on at least a portion thereof a composition, as described in any one of the respective embodiments herein.

In some embodiments, the article is selected from the group consisting of: transparent plastic surfaces, lenses, a package, and windows. In some embodiments, the article is a construction element, such as, but not limited to, paints, walls, windows, door handles, and the like. In some embodiments, the article according to the invention may be any optical article, such as a screen, a glazing for the automotive industry or the building industry, a mirror, an optical lens, or an ophthalmic lens. Exemplary articles include, but are not limited to, medical devices, organic waste processing device, fluidic device, an agricultural device, a package (e.g., a food packaging), a sealing article, a fuel container, a water and cooling system device and a construction element.

### The Process

According to an aspect of some embodiments of the present invention there is provided a process for coating a substrate with a mesoporous SiO₂-coating, comprising the steps of (a) providing a substrate selected from an hydrophilic substrate, or an at least partially oxidized substrate; and (b) contacting the substrate with the composition described hereinabove, under conditions suitable for forming the mesoporous SiO₂-coating, and bound the mesoporous SiO₂-coating to the substrate, thereby forming a coated substrate.

According to an aspect of some embodiments of the present invention there is provided a process for obtaining a coated substrate with a mesoporous SiO₂-coating, comprising the steps of: (a) providing a substrate selected from an hydrophilic substrate, or an at least partially oxidized substrate; and (b) contacting the substrate with a composition comprising (i) a silane compound represented by the formula Si(OR)₄, Si(R′)ₙ(OR)₄₋ₙ or a combination thereof, wherein R and R′ are each independently selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; and (ii) a surfactant, wherein a weight per weight (w/w) ratio of the silane compound and the surfactant is between 10:1 (w/w) to 40:1 (w/w), under conditions suitable for forming the mesoporous SiO₂-coating, and bound the mesoporous SiO₂-coating to the substrate, thereby forming a first coating layer on the substrate.

In some embodiments, the coated substrate is the coated substrate described hereinabove.

In some embodiments, the process further comprises a step (c) of washing the substrate to remove non-bound SiO₂-coating.

In some embodiments, the process is for receiving an anti-fogging composition.

In some embodiments, the process further comprises step (d) contacting the substrate with a solution comprising a hydrophobic agent selected from 1H,1H,2H,2H-perfluorododecyl trichlorosilane (FTS), octadecyl trichlorosilane (OTS), 1H,1H,2H,2H-perfluorodecyl triethoxysilane (FTES), octadecyl triethoxysilane (OTES), and any combination thereof, thereby forming a second layer.

In some embodiments, the contacting is selected from the group comprising: dipping, spraying, spreading, casting, rolling, adhering, printing, curing, or any combination thereof.

In some embodiments, the process is for receiving a composition and/or a coated substrate characterized by a water contact angle of at least 130°.

In some embodiments, the process is for receiving a superhydrophobic composition and/or coated substrate.

According to an aspect of some embodiments of the present invention there is provided a coated substrate, obtained by the process described hereinabove. In some embodiments, the coated substrate comprises a substrate and mesoporous SiO₂-coating, wherein: i) the mesoporous SiO₂-coating is covalently bound to at least a portion of the substrate, forming a first coating layer; ii) the first coating layer is characterized by a dry thickness between 0.001 μm to 10 μm; and iii) the first coating layer is characterized by a roughness between 1 nm and 100 nm, as measured by Atomic Force Microscope (AFM).

### Definitions

As used herein, the term “alkyl” describes an aliphatic hydrocarbon including straight chain and branched chain groups. Preferably, the alkyl group has 21 to 100 carbon atoms, and more preferably 21-50 carbon atoms. Whenever a numerical range; e.g., “21-100”, is stated herein, it implies that the group, in this case the alkyl group, may contain 21 carbon atoms, 22 carbon atoms, 23 carbon atoms, etc., up to and including 100 carbon atoms. In the context of the present invention, a “long alkyl” is an alkyl having at least 20 carbon atoms in its main chain (the longest path of continuous covalently attached atoms). A short alkyl therefore has 20 or less main-chain carbons. The alkyl can be substituted or unsubstituted, as defined herein.

The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” describes an all-carbon monocyclic or fused ring (i.e., rings which share an adjacent pair of carbon atoms) group where one or more of the rings does not have a completely conjugated pi-electron system. The cycloalkyl group may be substituted or unsubstituted, as indicated herein.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted, as indicated herein.

The term “alkoxy” describes both an —O-alkyl and an —O-cycloalkyl group, as defined herein.

The term “aryloxy” describes an —O-aryl, as defined herein.

Each of the alkyl, cycloalkyl and aryl groups in the general formulas herein may be substituted by one or more substituents, whereby each substituent group can independently be, for example, halide, alkyl, alkoxy, cycloalkyl, alkoxy, nitro, amine, hydroxyl, thiol, thioalkoxy, thiohydroxy, carboxy, amide, aryl and aryloxy, depending on the substituted group and its position in the molecule. Additional substituents are also contemplated.

The term “halide”, “halogen” or “halo” describes fluorine, chlorine, bromine or iodine.

The term “haloalkyl” describes an alkyl group as defined herein, further substituted by one or more halide(s).

The term “haloalkoxy” describes an alkoxy group as defined herein, further substituted by one or more halide(s).

The term “hydroxyl” or “hydroxy” describes a —OH group.

The term “thiohydroxy” or “thiol” describes a —SH group.

The term “thioalkoxy” describes both an —S-alkyl group, and a —S-cycloalkyl group, as defined herein.

The term “thioaryloxy” describes both an —S-aryl and a —S-heteroaryl group, as defined herein.

The term “amine” describes a —NR′R″ group, with R′ and R″ as described herein.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine.

The term “heteroalicyclic” or “heterocyclyl” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofurane, tetrahydropyrane, morpholino and the like.

The term “carboxy” or “carboxylate” describes a —C(═O)—OR′ group, where R′ is hydrogen, alkyl, cycloalkyl, alkenyl, aryl, heteroaryl (bonded through a ring carbon) or heteroalicyclic (bonded through a ring carbon) as defined herein.

The term “carbonyl” describes a —C(═O)—R′ group, where R′ is as defined hereinabove.

The above-terms also encompass thio-derivatives thereof (thiocarboxy and thiocarbonyl).

The term “thiocarbonyl” describes a —C(═S)—R′ group, where R′ is as defined hereinabove.

A “thiocarboxy” group describes a —C(═S)—OR′ group, where R′ is as defined herein.

A “sulfinyl” group describes an —S(═O)—R′ group, where R′ is as defined herein.

A “sulfonyl” or “sulfonate” group describes an —S(═O)2—R′ group, where Rx is as defined herein.

A “carbamyl” or “carbamate” group describes an —OC(═O)—NR′R″ group, where R′ is as defined herein and R″ is as defined for R′.

A “nitro” group refers to a —NO₂ group.

A “cyano” or “nitrile” group refers to a —C≡N group.

As used herein, the term “azide” refers to a —N₃ group.

The term “sulfonamide” refers to a —S(═O)₂—NR′R″ group, with R′ and R″ as defined herein.

The term “phosphonyl” or “phosphonate” describes an —O—P(═O)(OR′)₂ group, with R′ as defined hereinabove.

The term “phosphinyl” describes a —PR′R″ group, with R′ and R″ as defined hereinabove.

The term “alkaryl” describes an alkyl, as defined herein, which substituted by an aryl, as described herein. An exemplary alkaryl is benzyl.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazole, pyridine, pyrrole, oxazole, indole, purine and the like.

As used herein, the terms “halo” and “halide”, which are referred to herein interchangeably, describe an atom of a halogen, that is fluorine, chlorine, bromine or iodine, also referred to herein as fluoride, chloride, bromide and iodide.

The term “haloalkyl” describes an alkyl group as defined above, further substituted by one or more halide(s).

### General

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

### Chemicals

The following analytical-grade chemicals were purchased from Sigma-Aldrich and used without further purification: cetyltrimethylammonium bromide (CTAB), cetyltrimethylammonium chloride (CTAC), ethanol (anhydrous, 99.9%), ammonium hydroxide (NH₄OH, 28%), and sodium hydroxide. The UV active trialkoxy silane blocking agents, 2-hydroxy-4-(3-triethoxysilylpropoxy) diphenylketone (SiUV, 95%), 2-hydroxy-4-(methyl di ethoxy silyl prop oxy) diphenylketone and 3-carb azolyl propyltri ethoxy silane were purchased from Gelest. Double distilled water was obtained from a TREION™ purification system. Polyethylene (PE) films, non-treated and corona treated, were provided by Syfan, Israel. Non-treated and corona/plasma treated PP, PC, PMMA, PET, etc. films were provided by Mapal Ltd and Plazit Ltd, Israel.

### Methods

### Preparation of UV Silica Coatings

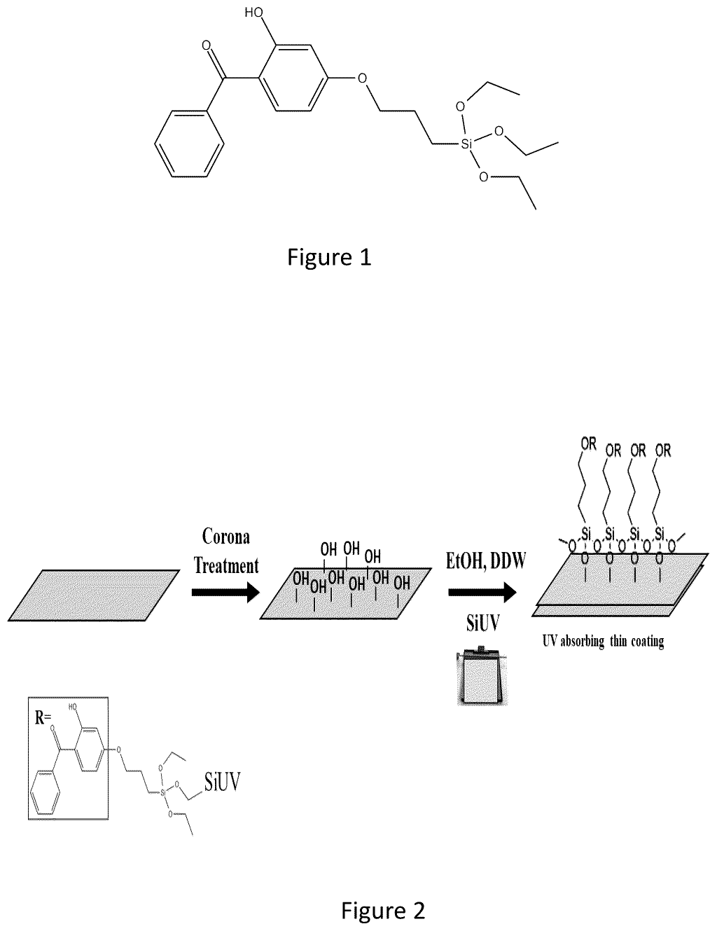

In a typical experiment, corona/plasma treated polymeric films (e.g., PE, PP) were cut into half A4 sheets. Silica UV coatings were prepared by using a modified Stöber polymerization procedure of the monomeric silane compound 2-hydroxy-4-(3-triethoxysilylpropoxy) diphenylketone (SiUV, FIG. 1). Briefly, 10.9 mL of ethanol, 1.8 mL of water, 0.22 mL of ammonium hydroxide (28%) or 0.22 mL of sodium hydroxide (0.02M) and 0.65 mL of SiUV monomer were added to a vial. The solution was shaken at room temperature for about 15 min then spread on the oxidized surface (e.g., corona/plasma) treated polymeric films, e.g., PE, with a Mayer rod (RK Print Coat Instruments Ltd., Litlington, Royston). The films were then dried with N₂ gas and underwent thermal curing at 70° C. for 1 minute. This coating process was re-applied onto the film as many times as needed. Coatings of different qualities were observed by changing the coating parameters, e.g., reagent concentrations, reaction time, solvent, ethanol/water ratio, monomeric silane compound containing different UV absorbing functionality, polymeric film roughness, coating type (spraying, dipping and spreading), drying temperature and time, film thickness, etc.

Similar trials were accomplished in presence of less than 0.5% (w/v), e.g., 0.1%, CTAB or CTAC, thereby mesoporous UV silica coatings were formed.

### Characterization

Surface morphology of the films was characterized with a FEI HRSEM Magellan 400 L high resolution scanning electron microscope (HRSEM) operating at 5 kV. The sample was coated with iridium in vacuum before viewing under HRSEM.

Fourier transform infrared (FTIR) measurements of the plastic films and coated films were performed by the attenuated total reflectance (ATR) technique, using Bruker ALPHA-FTIR QuickSnap™ sampling module equipped with Platinum ATR diamond module.

UV-vis spectra of the films in the range of 200-600 nm were determined in absorption and transmissions modes, using a Cary 5000 spectrophotometer (Agilent Technologies Inc.). Average UV absorbance and transmission were calculated over the range of 220-350 nm.

The optical parameters of transmittance, haze, and clarity of the films were measured on a BYK Gardner haze-gard plus in accordance with ASTM D1003 “Standard Test Method for Haze and Luminous Transmittance of Transparent Plastics”.

The stability of the coatings was examined by an adhesive tape pressing onto the coating film and then slowly peeling off. The process was repeated ten times after which the tested film was introduced to the UV-vis transmission test to ensure that the silica UV coating properties were not damaged.

For all measurements uncoated and non-treated films were used as references.

Similar results were obtained for polymeric films other than PE, e.g., PET, PVC, PC, PMMA, etc.

Similar results were also observed by substituting the UV silane compound for other silane compounds containing UV absorbing functionality, e.g., 2-hydroxy-4-(3-methyl di ethoxy silyl prop oxy) di phenyl ketone, 2-(2-tri ethoxy silyl prop oxy-5-methyl-phenyl) benzotriazole, etc.

Similar results were obtained substituting the Mayor-rod coating process for spraying or dipping.

### Materials

The following analytical-grade chemicals were purchased from Sigma Aldrich: ethanol (EtOH, HPLC), ammonium hydroxide (NH₄OH, 28%), sodium hydroxide (NaOH), tetraethyl orthosilicate (TEOS, 99%), 1H, 1H, 2H, 2H-perfluorododecyl trichlorosilane (FTS), octadecyl trichlorosilane (OTS), 1H, 1H, 2H, 2H-perfluorodecyl triethoxysilane (FTES), octadecyl triethoxysilane (OTES), cetyltrimethylammonium bromide (CTAB) and cetyltrimethylammonium chloride (CTAC). N-(3-triethoxysilylpropyl) gluconamide (TSPG, 30%) and PEGylated silane monomers were purchased from Gelest and polyvinylpyrrolidone (PVP) was purchased from Acros Organics. All materials were used without further purification. Double distilled water was obtained from a TREION™ purification system. Non-treated and surface oxygen treated polymeric films, e.g., polyethylene (PE), smooth (transparent) polypropylene (t-PP) and roughened PP (r-PP), polystyrene (PS), polymethylmethacrylate (PMMA), polyvinyl chloride (PVC), polycarbonate (PC), polyethylene terephthalate (PET).

### Methods

### Preparation of Mesoporous and Non-Mesoporous SiO₂ M/NPs Thin Coatings on Polymeric Films

Colloidal (free) and surface bound mesoporous and non-mesoporous SiO₂ M/NPs were prepared using a modified Stöber polymerization process of TEOS in presence or absence of a mesoporous surfactant producer and a desired polymeric film, e.g., PE or PP. In a typical experiment, the film was first underwent surface oxygen treatment, e.g., corona or plasma treated, then inserted in room temperature into a container where the synthesis took place for a desired period of time, e.g., 10 min. Various sizes of free and bound SiO₂ particles were prepared by changing different polymerization parameters, e.g., TEOS concentration, base concentration e.g. NH₄OH, KOH and NaOH and mesoporous producing surfactant concentration, e.g., CTAB or CTAC.

The formed SiO₂ bound films were washed of free SiO₂ M/NPS with EtOH and air-dried. Table 1 summarizes the different conditions used to prepare free and bound mesoporous and non-mesoporous SiO₂ particles of different sizes and size distributions.

TABLE 1
Synthetic parameters used to form free and bound mesoporous and
non-mesoporous SiO₂ M/NPs of different sizes on polymeric films.

| | EtOH | H₂O | NH₄OH | TEOS | CTAB % |
|---|---|---|---|---|---|
| Sample | (mL) | (mL) | (mL) | (mL) | (w/v) |
| 1 | 23.5 | 0.4 | 1 | 0.8 | — |
| 2 | 23.5 | 0.4 | 1 | 0.8 | 0.04 |
| 3 | 23.5 | 0.4 | 1 | 0.8 | 0.1 |
| 4 | 23.5 | 0.4 | 1 | 0.8 | 0.5 |
| 5 | 23.5 | 0.4 | 1 | 0.8 | 1 |
| 6 | 23.5 | 0.4 | 1 | 0.8 | 2 |

### Super-Hydrophobic Durable Thin Coatings

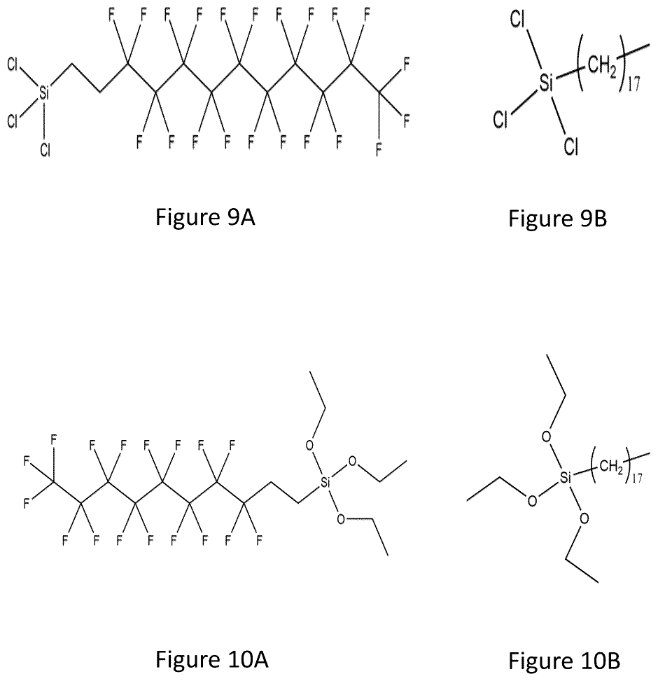

The SiO₂ particle coated film substrates underwent an additional surface oxygen treatment then were placed in another container where the synthesis took place. A solution containing 20 mL of dry heptane and 10 mg of FTS or OTS (FIGS. 9A-B) was added to the container and shaken for 1 h. The films were then washed with ethanol, air-dried then underwent thermal curing at 70° C. for 10 minutes.

Alternatively, 3.75% (v/v) of FTES or OTES (FIGS. 10A-B) in a basic solution containing EtOH, H₂O and mesoporous surfactant producer was sprayed or spread on a previously activated polymeric film using a Mayer rod. The film was then air-dried then underwent thermal curing at 70° C. for 10 minutes.

Alternatively, a one-step reaction in a basic solution containing EtOH, H₂O, mesoporous producer surfactant and FTES or OTES (FIGS. 10A-B) was sprayed or spread on a previously activated polymeric film using a Mayer rod. The film was then air-dried then underwent thermal curing at 70° C. for 10 minutes.

In-Situ Anti-Fog Thin Coating by Spreading on PE Films

Anti-fog thin coatings were applied on PE films using a modified Stöber polymerization process of different silanes. In a typical experiment, 20 mM of NaOH and 2.86 mM of CTAB were dissolved in a 1:6 ratio water/ethanol solution. A polymeric film was then treated with corona (300 W·min/m 2) after which the desired silane mixture was added to the solution (Table 2). The solution was immediately spread on the film with a Mayer rod (6 μm wet film deposit thickness) and was left to dry for 2 min in room temperature.

Additionally, different concentrations of PVP were added to the solution (Table 2, samples 4-7). The coated film was then air dried, washed with ethanol then air dried again.

Additionally, 0.2% w/v of silane-PEG-NH₂ was added to the solution with the parameters of sample 2. The coated film was then air dried, washed with ethanol then air dried again.

TABLE 2
Synthetic parameters of the anti-fog coating solution
used for spraying or spreading on an activated film.

| | H₂O/EtOH | NaOH | CTAB | TEOS | TSPG | PVP % |
|---|---|---|---|---|---|---|
| Sample | ratio (mL) | (mM) | (mM) | (mM) | (mM) | (w/v) |
| 1 | 1:6 | 20 | 2.86 | 75.2 | 21.6 | — |
| 2 | 1:6 | 20 | 2.86 | 60.16 | — | — |
| 3 | 1:6 | 20 | — | 75.2 | 21.6 | — |
| 4 | 1:6 | 20 | 2.86 | 60.16 | — | 0.05 |
| 5 | 1:6 | 20 | 2.86 | 60.16 | — | 0.1 |
| 6 | 1:6 | 20 | 2.86 | 60.16 | — | 0.15 |
| 7 | 1:6 | 20 | 2.86 | 60.16 | — | 0.2 |

### Characterizations

Dynamic Light Scattering (DLS)

The hydrodynamic diameter and diameter distribution of the free particles in an aqueous continuous phase were measured by dynamic light scattering (DLS) with photon cross-correlation spectroscopy (Nanophox particle analyzer, Sympatec GmbH, Germany).

### High Resolution Scanning Electron Microscope (HRSEM)

For dry size and size distribution imaging and morphological characterization of the free and surface bound SiO₂ M/NPs, high-resolution scanning electron microscope (HRSEM) images were taken using a FEI XHR-SEM Magellan 400 L scanning electron microscope operating at 5 kV. A drop of dilute aqueous samples containing the free SiO₂ NPs was spread on a silicon wafer and dried at room temperature. The dried samples were coated with iridium in vacuum before viewing under HRSEM.

For characterization of the dry coated polymer films the films were attached to the silicon wafer with carbon tape, coated with iridium in vacuum and then studied by HRSEM.

### Atomic Force Microscope (AFM)

AFM measurements were performed with a Bio Fast Scan scanning probe microscope (Bruker AXS). All images were obtained using the Peak Force QNM (PeakForce™ Quantitave Nanomechanical Mapping) mode with a Fast Scan C (Bruker) silicon probe (spring constant of 0.45 N/m).

The measurements were performed under environmental conditions in the acoustic hood to minimize vibrational noise. The images were captured in the retrace direction with a scan rate of 1.6 Hz. The image resolution was 512 samples/line. For image processing and thickness analysis, Nanoscope Analysis software was used. The “flattening” and “planefit” functions were applied to each image.

### Contact Angle (CA)

Sessile drop water contact angle measurements were performed using a Goniometer (System OCA, model OCA20, Data Physics Instruments Gmbh, Filderstadt, Germany). Double distilled water drops of 3 μl were placed on four different areas of each film and images were captured a few seconds after deposition. The static water contact angle values were determined by Laplace-Young curve fittings. All measurements were done in the same conditions.

### Durability Test

Adhesion tests were done to examine the strength of the interaction between the SiO₂ coating and the film. The test consisted of firmly pressing an adhesive tape onto the coated film then slowly peeling it off as described in the literature. For each coating the procedure was performed 25 times.

### Optical Properties (Haze and Gloss)

Haze measurements were performed using a Haze-Gard Plus 4725 model according to the ASTM D1003 standard (BYK-Gardner, Germany). Gloss measurements were performed using a BYK Gardner Micro-Gloss 45° according to the ASTM D2457 standard. Mean values and standard deviations of haze and gloss were obtained from at least 3 measurements for each different film samples.

### Hot-Fog Test

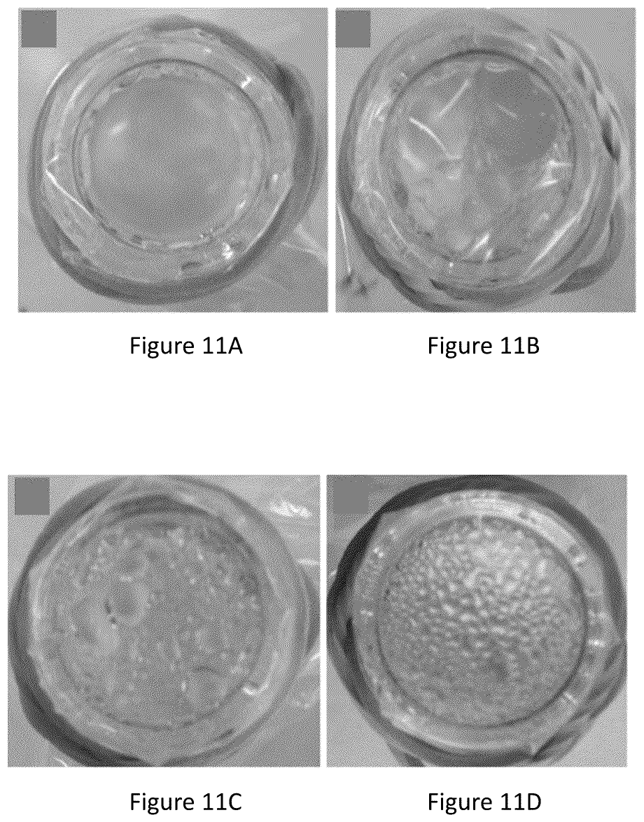

Anti-fogging properties were evaluated using the hot-fog test which simulates real fogging conditions. A 20 mL vial was filled with 5 mL of water, after which the polymeric film sample was placed with the treated side facing the water and secured to the vial's opening. The vial was then heated to 60° C. for three hours resulting in water condensing onto the treated polymeric film sample. Visibility of the sample was periodically observed and graded at each interval from A (completely transparent) to D (completely fogged) (FIGS. 11A-D).

### Cold-Fog Test

Cold-fog tests are used to simulate real fogging conditions particularly in plastics used for refrigeration purposes. A beaker was filled with water, after which the polymeric film sample was placed with the treated side facing the water and secured to the opening. The beaker was then placed in a refrigerator at 4° C. for three hours resulting in water condensing onto the treated film sample. Visibility of the sample was periodically observed and graded at each interval from A (completely transparent) to D (completely fogged).

### Example 1

### Silane-Based UV-Blocking Coatings

In the present patent application, the silane monomer 2-hydroxy-4-(3-triethoxysilylpropoxy) diphenylketone (SiUV) (FIG. 1), was polymerized in ethanol/water continuous phase under basic conditions. Durable UV absorbing thin coatings onto polyethylene (PE) films were then obtained by dipping, spraying or spreading the polymerized UV absorbing silane polymers in/onto the surface oxidized PE films, followed by a drying process.

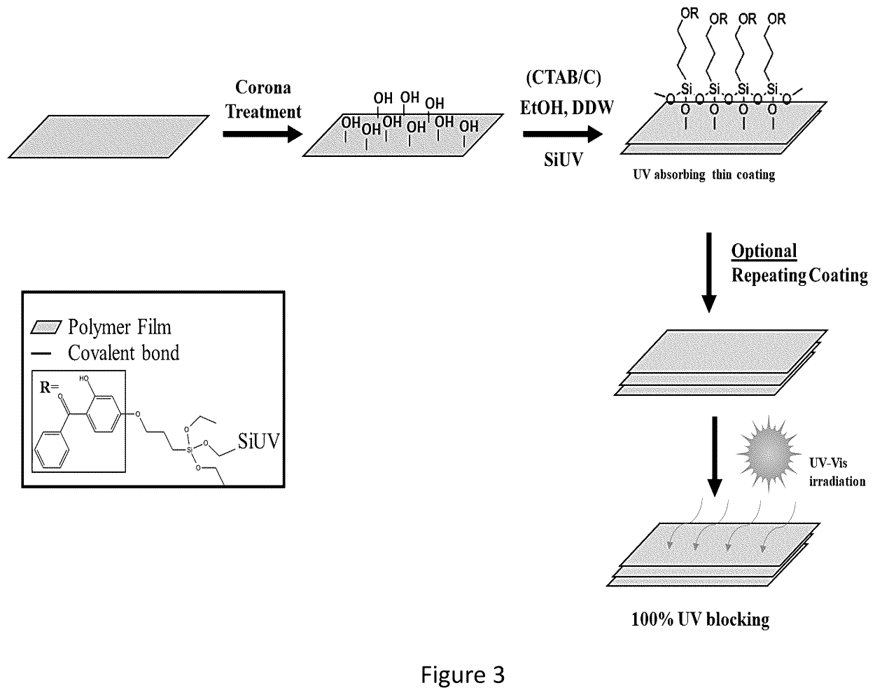

FIG. 2 presents the formation of the UV absorbing polymer via polymerization of the SiUV monomer in ethanol/water continuous phase under basic conditions, followed by spreading via Mayor rod. The obtained dispersion onto the polymeric film. The durability of the coatings onto the surface oxidized films is probably due to self-cross-linking (polymerization) between the silane monomeric units to form siloxane bonds as well as form covalent bonds with the oxidized film surface, as shown in FIG. 3.

The present study illustrates that increasing the concentration of the UV absorbing silane monomer in the continuous phase or thickness of the produced polymeric coating on the PE films increased the UV absorbance of the films, up to approximately 100% (FIG. 3). In addition, under these conditions durable cross-linked coatings were obtained and no significant damage to the optical properties of the PE films was observed. Furthermore, enhancing the optical properties of the UV blocking coatings using CTAB/CTAC revealed significant potential to extend the industrial potential into food packaging and agriculture applications.

Similar results as described above were also observed by substituting the PE films for other plastic films such as PP (polypropylene), PET (polyethylene terephthalate) ant its derivatives, PMMA (polymethylmethacrylate), PS (polystyrene), PVA (polyvinyl alcohol) and PC (polycarbonate) films, or by substituting the UV absorbing silane monomer former used SiUV for the coating process for other silane monomer containing different UV absorbing functionality, e.g., 2-hydroxy-4-(methyl diethoxysilylpropoxy) diphenylketone and 3-carbazolylpropyltriethoxysilane.

### High Resolution Scanning Electron Microscopy (HRSEM)

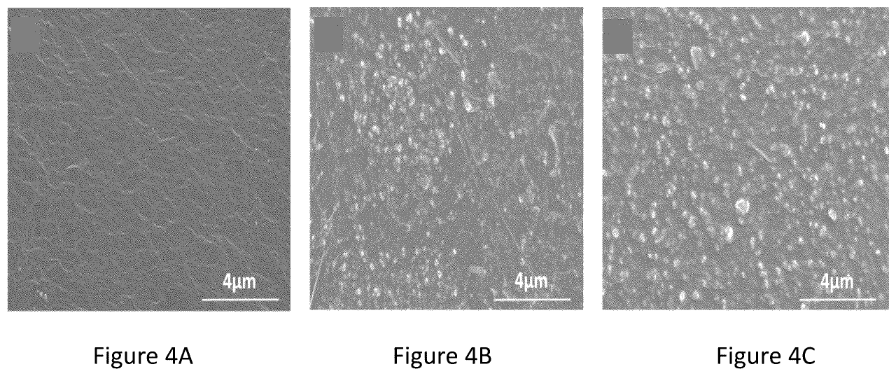

Silica UV coatings were prepared, as described in the experimental section, via polymerization of SiUV in an appropriate continuous phase such as ethanol or ethanol/water. The solution was then spread on surface oxidized plastic films with a Mayer rods of different thicknesses. Coatings were also produced by dipping the oxidized substrate/s in the polymerization solution/dispersion polymerization system for a while. Surface oxidation of the films (sheets) can be accomplished by chemical etching, oxygen plasma or corona treatments. The SiUV coatings onto PE films were performed with 5% (w/v) of the SiUV monomer in the continuous phase with a wet thickness of 120 μm using a Mayer rod. Images of the dry coated films were taken by HRSEM showing the uncoated corona-treated PE film FIG. 4A, and of the SiUV coated films coated with one and two layers (FIGS. 4B, and 4C, respectively). The HRSEM images clearly show a relatively smooth surface of the corona-treated PE compared to the rough surface of the coated PE films (FIGS. 4B-C). Furthermore, it can be observed that there is a proportional increase in surface roughness depending on the number of layers applied onto the film.

It should be noted that surface oxidation of the polymeric films (e.g., by corona/plasma treatment) was found to be essential for the SiUV coating. In absence of surface oxidation, no significant coating was observed.

### Attenuated Total Reflectance (ATR)

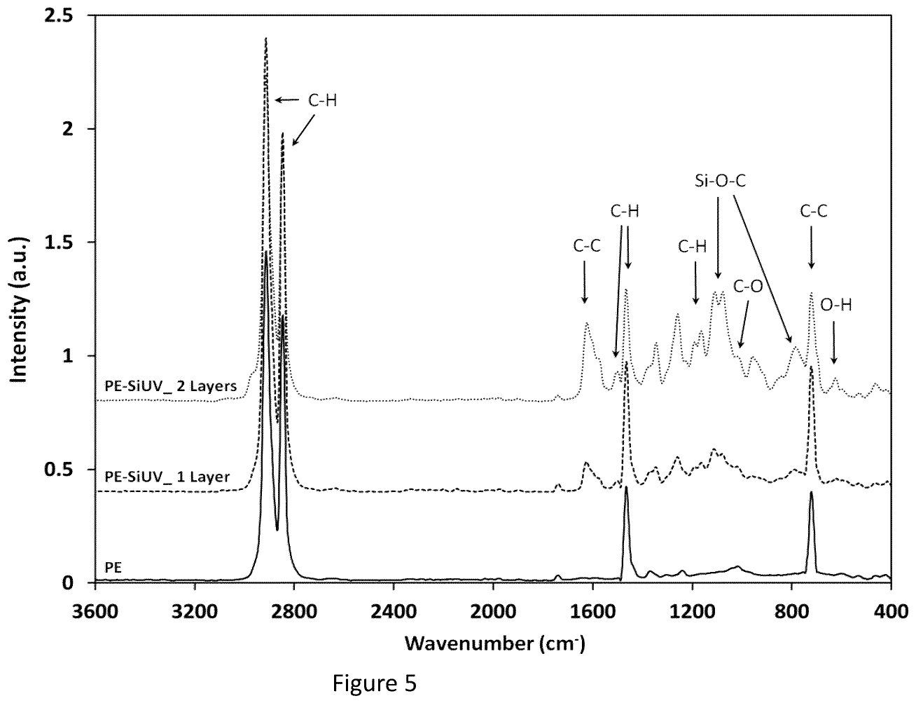

FIG. 5 illustrates the ATR spectra of PE films before and after the SiUV coatings. The spectrum for PE shows only vibrations of methylene groups corresponding to the peaks positioned at 2913 and 2846 cm⁻¹ (C—H asymmetric stretching), 1465 cm⁻¹ (C—H bending), and 719 cm⁻¹ (C—C rocking).

For spectrum of PE films coated with SiUV (PE-SiUV) shows vibrational peaks indicating to the presence of SiUV on the surface. The peak at 1190 cm⁻¹ shows the rocking mode of C—H in propoxy groups bonded to the Si atom. The Si—O—C asymmetric stretching vibration peaks are located at 1074 cm⁻¹ and 1109 cm⁻¹. In addition, at 786 cm⁻¹ we can find a medium band which is due to the symmetric stretching of the Si—O—C vibration. The C—O asymmetric stretching band is located at 1017 cm⁻¹ and a wide vibration O—H group assigned at 625 cm⁻¹. The aromatic ring C—C stretching vibrations strong bands are determined at 1624 and 1578 cm⁻¹.

### UV-VIS Spectroscopy

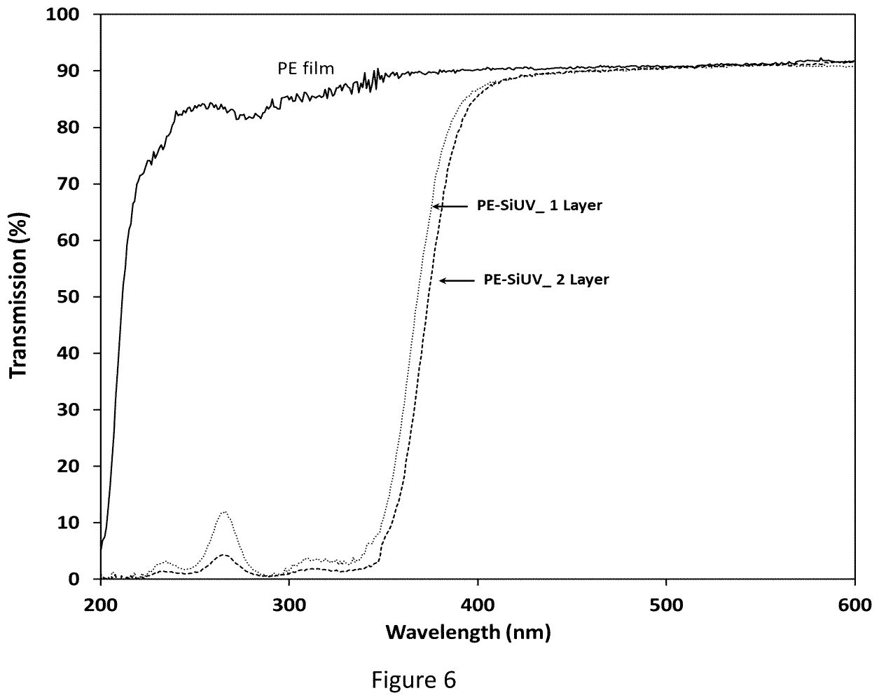

The transmission of UV-visible light through PE films before and after the SiUV coatings is clearly dependent on the coating as well as the number of coatings, thickness (FIG. 6). A clear difference is exhibited in FIG. 6 between the uncoated and corona-treated PE films coated with one layer of SiUV (PE-SiUV_1 Layer). The SiUV coated film was found to substantially decrease UV transmission from 90% transmission for the untreated PE film to 3.8% transmission for the PE-SiUV_1 Layer film. Additionally, increasing the number of coating layers or the coating thickness led to a further decrease in UV transmission from 3.8% transmission of the PE film coating with one layer of SiUV to 1.5% transmission for the PE film coated with two layers of SiUV. These results demonstrate an excellent coating for blocking UV radiation through a transparent PE film which can be useful for some industrial applications such as food wrap and plastic windows.

Similar results were observed wherein a mesoporous SiUV coating was prepared by adding to the coating process CTAB or CTAC, 0.1% (w/v) or less.

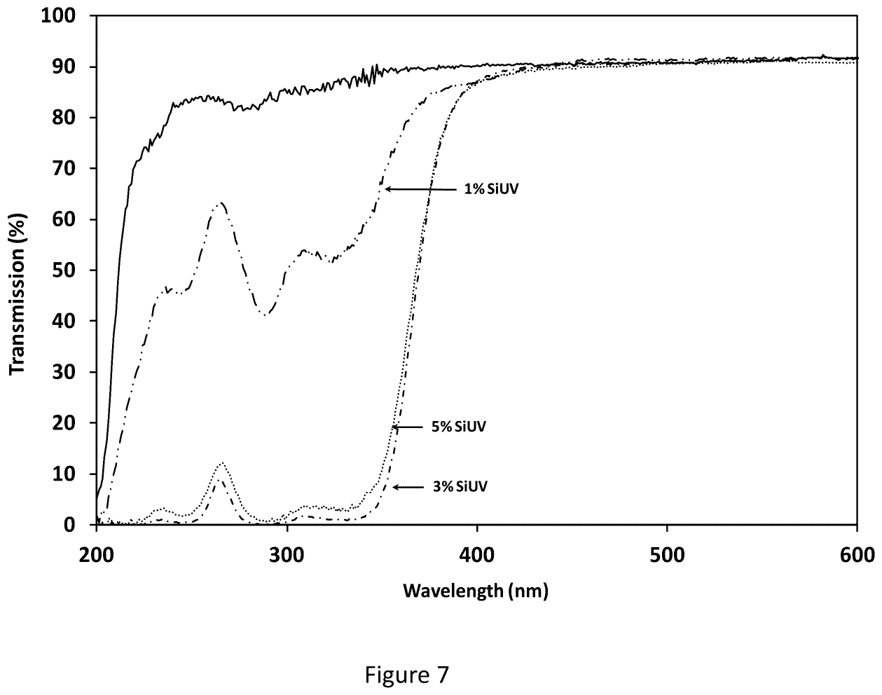

FIG. 7 demonstrates the transmission of UV-visible light through corona-treated PE films before and after the different concentrations of the SiUV monomer coatings. A clear difference is exhibited between the uncoated and coated PE films. All the coated films are with one layer of SiUV monomer. Almost of the SiUV coated films were found to significantly decrease UV transmission from 90% transmission for the uncoated PE film to 1.64%, 3.8%, and 50.3% transmission for the 3%, 5% and 1% SiUV PE film, respectively. The dry thicknesses of the different coatings are summarized in Table 3.

TABLE 3
Dry thicknesses of the SiUV coatings prepared with different
monomer concentrations. The wet thickness of the SiUV monomer
in the continuous phase is 120 μm using a Mayer rod.

| Monomer Concentration (%) | Dry Coating Thickness (μm) |
|---|---|
| 1 | 1.2 |
| 3 | 3.6 |
| 5 | 6 |

### Durability of the Coatings

The durability of the SiUV coatings was evaluated using the adhesion tape test after the films were first characterized by the UV-vis transmission test. All coatings exhibited the same UV-blocking properties as shown before the tests (FIG. 7), indicating that the coatings are stable and resistant to the mechanical abrasions. It should also be noted that the SiUV coating remained stable after at least two years at room temperature conditions.

Similar results as described above were also observed by substituting the PE films for other plastic films such as PP, PET and PET derivatives, PMMA, PS, silicon rubber, PVA (polyvinyl alcohol) and PC films, or by substituting the UV absorbing silane monomer former used 2-hydroxy-4-(3-triethoxysilylpropoxy) diphenylketone (SiUV) for the coating process for other silane monomer containing different UV absorbing functionality, e.g., 2-hydroxy-4-(methyl di ethoxy silylpropoxy) diphenylketone and 3-carbazolylpropyltriethoxysilane.

### Thermal Shrinkage

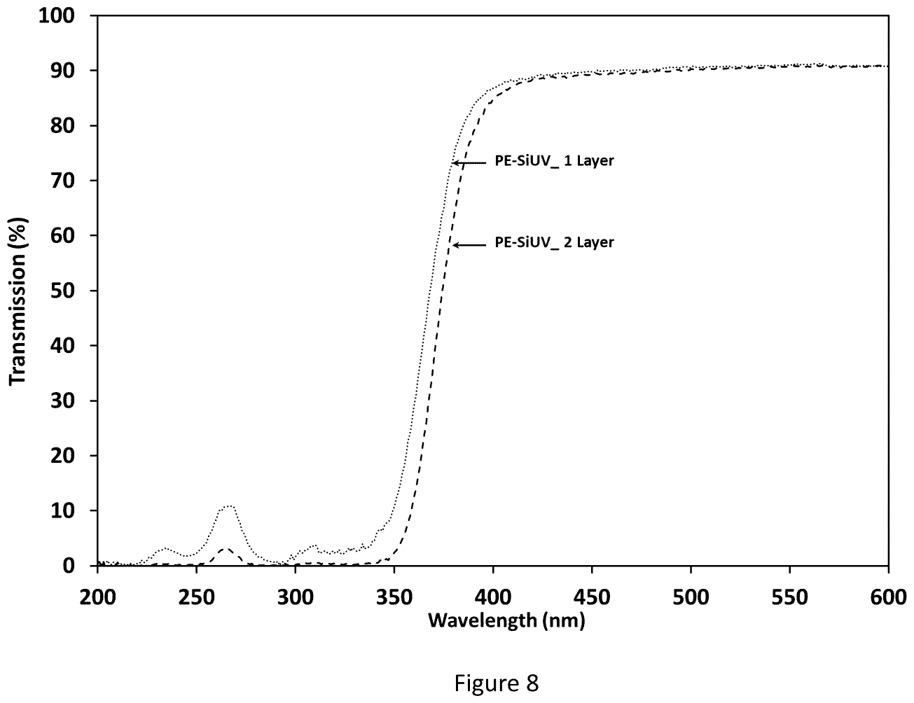

The SiUV coated PE film underwent thermal shrinking (30% shrinkage) to investigate the durability of coatings for industrial use. UV-vis transmission was performed on PE films coated with one and two layers before and after the thermal shrinkage. FIG. 8 demonstrates that the UV-blocking capabilities of both films were not affected by the shrinkage therefore demonstrating the stability of the SiUV coating. Furthermore, the thermal shrinkage slightly improved the UV-blocking capabilities of both the PE films coated with one and two layers of SiUV (3.8% to 3.6% and 1.7% to 0.5%, respectively).

### Optical Properties

The haze, gloss and light transmission of coated and uncoated PE films are shown in Table 4. While the total transmitted visible light includes both scattered and unscattered light, the haze is the fraction of light transmission which deviates greater than 2.5°. Haze values for the PE coated films were slightly increased but the transmission remained unchanged compared to the uncoated PE films.

TABLE 4

| Film type | Haze (%) | Transmission (%) |
|---|---|---|
| PE | 5.2 ± 0.2 | 91.7 ± 0.1 |
| PE-SIUV | 12.6 ± 1.5 | 91.7 ± 0.1 |
| PE-SiUV-CTAB | 8.5 ± 0.6 | 90.8 ± 0.2 |

It is interesting that coated films including CTAB surfactant at low concentration of 0.1% (w/w) exhibits very good optical properties and showed high potential for transparent UV-absorbent industrial products.

### Example 2

### Anti-Fogging Protection and Hydrophobic/Superhydrophobic Coatings

### Free and Surface Bound Mesoporous SiO₂ Particles on Polymeric Films

Mesoporous SiO₂ particles (MSPs) were prepared, as described in the methods section (Table 1), by polymerization of TEOS in an appropriate basic continuous phase containing EtOH, H₂O and mesoporous surfactant producers, e.g., CTAB or CTAC, in the presence of both surface non-oxidized and oxidized treated, e.g., corona treated, polymeric films. Two types of SiO₂ particles were formed: free MSPs dispersed in the continuous phase and MSPs tightly bound to the film surface. The coated films were easily removed from the free MSPs, then washed and dried, as described in the methods section resulting in an MSP coated film. Conversely, the surface non-oxidized treated films were scarcely coated with MSPs after washing the films with EtOH.

### Anti-Fogging Surfaces

### Dynamic Light Scattering (DLS) and High-Resolution Scanning Electron Microscope (HRSEM)

The addition of a surfactant such as CTAB or CTAC to the initial precursor solution is known not only to form mesoporous SiO₂ particles but, when placed in a basic solution, causes the formation of SiO₂ particles to aggregate as well (FIGS. 12A-F). This is due to the attraction between the positively charged head of CTAB/CTAC and the negatively charged oxygen anion on surface of SiO₂ particles in the continuous phase. Consequently, accurate DLS measurements of the particle hydrodynamic diameter for the CTAB/CTAC treated samples could not be measured.

HRSEM images of the CTAB/CTAC treated roughened PP (r-PP) films (FIGS. 12B-F) show the effect of the addition of the surfactant in the initial precursor solution. Images B-F show a hierarchical topography of the film surface in which agglomerated SiO₂ particles form the macro roughness and SiO₂ “flakes” form the micro roughness. A clear progression of surface SiO₂ flakes is shown which is dependent on the CTAB/CTAC concentration where 0.04% (w/v) (FIG. 12B) shows a lower micro-flake concentration and 2% (w/v) shows a higher concentration (FIG. 12F). CTAB/CTAC is known to create MSPs and at high concentrations can even create “wrinkled” MSPs. These wrinkled particles have a similar structure to that of the flakes.

### Atomic Force Microscopy (AFM)

A clear contrast is seen when comparing the resulting CTAB/CTAC treated coated film (FIGS. 12B-F) to a coated film without CTAB/CTAC treatment (FIGS. 13A-C). The CTAB non-treated sample, although showing large flake structures, lacks the dual surface roughness of micro and nano structures shown in all CTAB/CTAC treated samples. The impact of having the dual surface roughness is exhibited in Table 5 where the CTAB/CTAC treated sample (Table 1, sample 3) is twice as rough as the CTAB/CTAC non-treated sample (Table 1, sample 1).

TABLE 5
Measured roughness of a corona treated roughened PP
(r-PP) film and r-PP films coated with SiO₂ particles
in the absence (1) and presence of CTAB (2).

| Sample | r-PP* | 1 | 2 |
|---|---|---|---|
| Rq value (nm) | 36.7 | 58.4 | 116.9 |

*Corona-treated r-PP film at 400 W · min/m².

### Contact Angle

As stated previously, surface roughness and chemistry are key factors to achieve both super-hydrophobic and super-hydrophilic surfaces. HRSEM images of the MSP coated films (FIGS. 12B-F) show the high roughness resulting from the SiO₂ structure coating. This roughness provides a significant increase in surface area which, together with hydrophilic hydroxyl surface groups, can allow a water droplet to spread over the surface more easily. For samples 2-4 (Table 1) the droplet was completely spread over the surface presenting excellent super-hydrophilic characteristics (Table 6). Samples 5 and 6 (Table 1) showed relatively high contact angles when compared to the other MSP coated samples. This is attributed to the increased roughness of the film's surface as shown in FIGS. 12E and F. The roughness causes a decrease in the initial contact between the droplet and the surface hydroxyl groups which, much like in super-hydrophobic surfaces, creates an air pocket under the droplet thus lower the surface energy of the film. Consequently, the droplet will be in contact with a higher concentration of air pockets than surface hydroxyl groups which would hinder the spreading of the droplet across the highly roughened surface. Due to the very low contact angles, samples 2-4 (Table 1) have potential to be used as anti-fogging surfaces

TABLE 6
Sessile contact angles of a non-coated, corona treated, roughened
PP (r-PP) film and SiO₂ coated r-PP films in absence of CTAB
(1) and presence of increasing concentrations of CTAB as describe
in Table 1, samples 2-6. The drop volume used was 3 μL.

| Sample | r-PP* | 1 | 2 | 3 | 4 | 5 | 6 |
|---|---|---|---|---|---|---|---|
| Contact angle (°) | 56 ± 4 | 63 ± 2 | <5** | <5 | <5 | 54 ± 1 | 55 ± 3 |

*Corona-treated r-PP films at 400 W · min/m².
**The water droplet fully spread over the surface thus preventing accurate contact angle measurements

### Durability Test

The durability of the MSP coated film was tested to evaluate its viability for industrial applications. The tape test was applied to all samples, then the contact angle of the samples was subsequently measured. Table 7 shows no impact on the contact angles of samples 2-4 (Table 1) but a slight increase for samples 1, 5 and 6. This demonstrates the durability of the SiO₂ particle thin coating which gets its strength from the network of Si—O—Si bonds (self-crosslinking), comprising the SiO₂ particle and the bond between the functional surface groups on the film surface and the SiO₂ particle itself. It should also be noted that similar results were also obtained for samples 2-4 which were kept at room temperature for one year.

TABLE 7
Sessile contact angles of a non-coated, corona treated, roughened
PP (r-PP) film and SiO₂ coated r-PP films in absence of CTAB
(1) and presence of increasing concentrations of CTAB as describe
in Table 1, samples 2-6 (2-6), before and after being submitted
to the tape test. The drop volume used was 3 μL.

| | Sample | r-PP* | 1 | 2 | 3 | 4 | 5 | 6 |
|---|---|---|---|---|---|---|---|---|
| Contact | Before | 56 ± | 63 ± 2 | <5** | <5 | <5 | 54 ± 1 | 55 ± 3 |
| angle (°) | tape test | 4 | | | | | | |
| | After | | 65 ± 3 | <5 | <5 | <5 | 57 ± 2 | 59 ± 4 |
| | tape test | | | | | | | |

*Corona-treated r-PP film at 400 W · min/m². Each coating underwent the tape test a total of 25 times

### Anti-Fogging Application of the SiO₂ Layer

As previously mentioned, this thin layer of SiO₂ particles can be utilized for different practical industrial applications. One such application is for anti-fogging surfaces. A hot-fog test was used to simulate the conditions needed for fogging to occur on the film surface as described in the characterizations section. Although samples 2-4 show excellent super-hydrophilic activity, the hot-fog test was not able to be performed on these films due to their opaqueness resulting from their roughening during the manufacturing process. Due to this, a non-roughened transparent PP (t-PP) film was used instead and subjected to the MSP coating process described in Table 1, samples 2-4. The transparent PP films exhibited the same super-hydrophilic activity)(<5°. However, we chose to continue with sample 2 since its transparency was the best after the coating process. Therefore, the hot-fog test was performed for 180 min on the t-PP film coated with the parameters of Table 1, sample 2 (t-PP/MSP) as well as a t-PP film coated with the parameters of Table 1 sample 1 (t-PP/SiO₂) and a t-PP film treated with corona (400 W·min/m 2) for comparison. All films were graded according to FIGS. 11A-D at specific time intervals. Table 8 shows the grades given for anti-fogging activity at each time interval. The t-PP/MSP sample exhibited excellent anti-fogging activity throughout the experiment (Table 7). Conversely, t-PP/SiO₂ performed poorly for the first 120 min of the test but showed an improvement after 120 min and only after 180 min the surface became transparent. The corona-treated t-PP film showed a foggy surface throughout the experiment. t-PP/SiO₂ film showed better results than t-PP film due to higher concentrations of polar surface groups present on the surface, which results in a higher surface energy allowing the droplets to spread more easily. t-PP/MSP greatly increases the surface area allowing for an even higher concentration of surface polar groups which results in the droplet spreading rapidly across the surface. These results show the importance of the addition of CTAB/CTAC to the initial precursor solution resulting in transparent, highly roughened surfaces with excellent anti-fogging properties.

TABLE 8
Hot-fog test results for a transparent, corona treated, non-
coated t-PP film and t-PP films coated with SiO₂ in the absence
of CTAB according to the parameters of Table 1, sample 1
(t-PP/SiO₂) and in the presence of CTAB according to parameters
of Table 1, sample 2 (t-PP/MSP). Grades A-D (A being transparent
and D being foggy) are in accordance with FIG. 3.

| | Test Time (min) | | | | | | |
|---|---|---|---|---|---|---|---|
| Sample | 5 | 10 | 20 | 30 | 60 | 120 | 180 |
| t-PP* | D | D | D | D | D | D | D |
| t-PP/SiO₂ | D | D | D | D | D | C | A |
| t-PP/MSP | A | A | A | A | A | A | A |

*Corona-treated transparent t-PP film at 400 W · min/m².

### Optical Properties

Optical properties of the films were measured to determine if the coating has an effect on properties such as haze and gloss. These measurements are essential for determining the industrial applicability of the t-PP/MSP sample as an anti-fogging film. Haze measurements are categorized by the fraction of transmitted light which scatters and deviates by more than 2.58° from the incident beam while gloss is measured by the percentage of light reflected from the surface in a specular direction relative to the incident beam. A low haze value is an indication that the film has high transparency. Table 7 shows that both the SiO₂ particle and MSP coatings have little to no impact on the films haze (9.1±0.48% and 11.1±0.29%, respectively) as compared to the uncoated t-PP film (8.95±0.45%). The slight increase in haze of the t-PP/MSP sample is due to the roughness of the surface (Table 5) which increases the light scattering effect, thus causing the slightly hazier appearance. The same can be said for the difference in gloss results in Table 9 which is affected by the reflective index and the topography of the film surface. The rougher surface of the t-PP/MSP sample results in an increase in light scattering, resulting in less light being reflected back to the detector.

TABLE 9
Optical measurements of haze and gloss for a transparent, corona
treated, non-coated t-PP film and t-PP films coated with SiO₂
in the absence of CTAB according to the parameters of Table 1, sample
1 (t-PP/SiO₂) and in the presence of CTAB according to parameters
of Table 1, sample 2 (t-PP/MSP).

| Sample | Haze (%) | Gloss (%)** |
|---|---|---|
| t-PP* | 8.95 ± 0.45 | 49.3 ± 2.8 |
| t-PP/SiO₂ | 9.1 ± 0.48 | 45.8 ± 2.6 |
| t-PP/MSP | 11.1 ± 0.29 | 30.5 ± 2.6 |

*Corona-treated transparent PP film at 400 W · min/m².
**The incident light was measured at a 45° angle.

Similar results were obtained by spraying the solution on a corona treated t-PP film or by using a Mayer rod to spread the solution on an activate t-PP film as described in the methods section as well as the use of CTAC substituted for CTAB in both types of syntheses (in a container, using a spray and using a Mayer rod)

### In-Situ Anti-Fogging Coating Via Spraying and Spreading Methods Anti-Fogging Application

Anti-fogging properties were determined through cold-fog tests and were graded from A (completely transparent) to D (completely fogged). It is clearly shown from Table 10 that samples 1 and 2 exhibit superior anti-fogging properties as compared to the PE substrate. This is due to the silane coating of each sample where surface hydroxyl groups are present which increases both the surface energy and surface wettability of the water droplets. Sample 3, which used the same synthetic parameters of sample 1 excluding CTAB, exhibited very poor anti-fogging properties thus highlighting the importance of CTAB in this synthesis. These tests were repeated with similar results.

Similar results were obtained with the addition of silane-PEG-NH₂ to the solution parameters of sample 2.

TABLE 10
Cold-fog test for a PE substrate (PE) and samples 1-3. The test
was performed for 180 min with grades A-D given throughout.

Test Time (min)

| Sample | 5 | 10 | 20 | 30 | 60 | 120 | 180 |
|---|---|---|---|---|---|---|---|
| PE | D | D | D | D | D | D | D |
| 1 | A | A | A | A | A | A | A |
| 2 | A | A | A | A-B | A-B | A-B | A-B |
| 3 | D | D | D | D | D | D | D |

### Heat Sealing Tests of the Coated Films for Packaging Applications

Films presenting with anti-fogging properties are useful for packaging applications where water can harm the packaged product. Therefore, the coated films were tested using a heat sealer to investigate their sealing capabilities. The coated films were folded in half so that the coated side on one half of the film was sealed to the coated side of the other half. Heat was applied to the coated films for 3 sec and were subsequently rated as having either a weak or strong seal. Films coated without PVP (Table 2, samples 1-3) resulted in a weak seal while samples coated with PVP (Table 2, samples 4-7) resulted in a strong seal. This is due to the long chain PVP polymers which, when exposed to heat, can twist around and anchor to one another which improves the sealing of the coated film. Similar results were obtained with the addition of silane-PEG-NH₂ to the solution parameters of sample 2. Conversely, films coated without PVP lacked the suitable amount of physical bonds to the opposite half of the coated film which resulted in a weak bond.

### Super-Hydrophobic Surfaces

### Super-Hydrophobization of the SiO₂ Layer

Another practical application, using the SiO₂ layer as a chemical platform is for super-hydrophobic surfaces. To achieve this, the SiO₂ and MPS coated r-PP films were treated again with corona and underwent the super-hydrophobization process by dissolving FTS or OTS in dry heptane in the container with the activated coated films as described in the methods section. This resulted in a thin layer of FTS bonded to the surface SiO₂ or MPS layer (SiO₂/r-PP-MPS r-PP/MPS-FTS).

### X-Ray Photoelectric Spectroscopy (XPS)

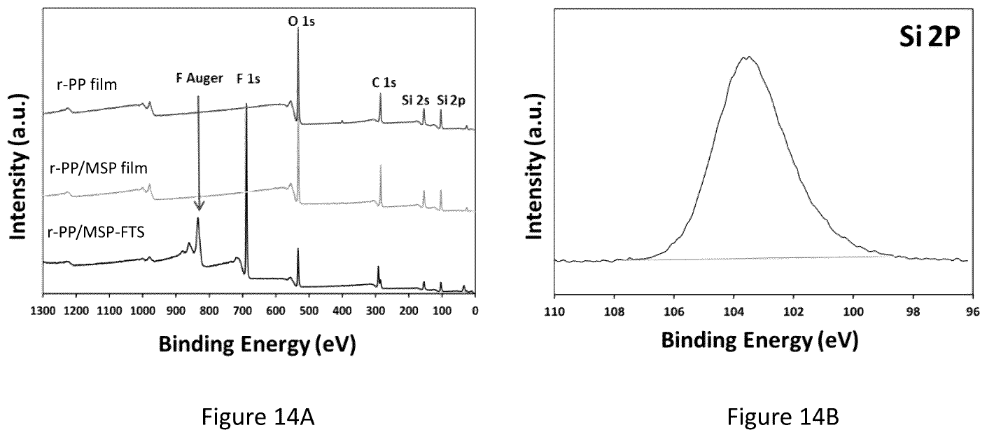

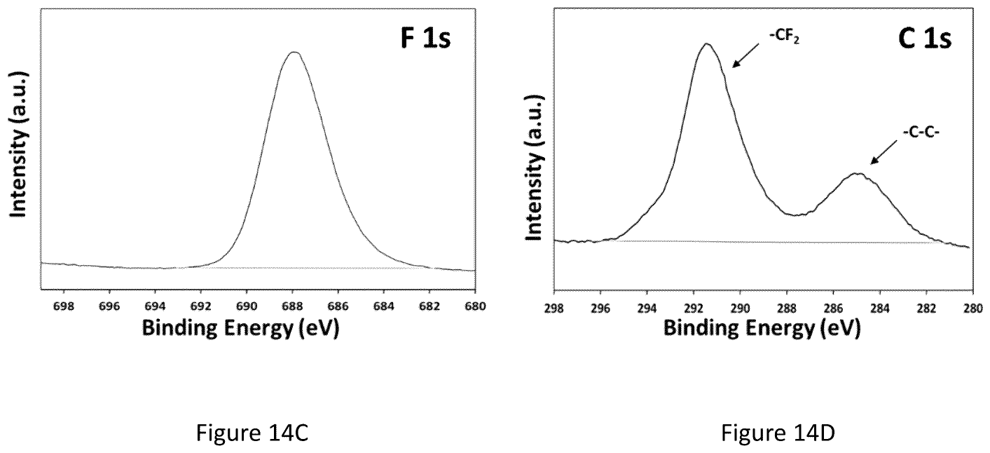

The chemical composition of the r-PP/MPS-FTS thin film was measured using XPS. FIG. 6A exhibits characteristic peaks of Si 2p (FIG. 14B) at 103.1 eV, F 1s (FIG. 14C) at 688 eV and C 1s (FIG. 14D) at 284.8 eV for C—C bonds and at 295.1 eV for C—F₂ bonds. The peaks corresponding to fluorine (C—F₂ and F 1s) only appeared in the spectra containing FTS (FIG. 14A, bottom line) which confirms that FTS is indeed bonded to the SiO₂ coating. Peaks corresponding to CTAB/CTAC are not discernable when comparing the spectra of the SiO₂ coated r-PP/SiO₂ film to the r-PP/MPS film. This is attributed to the washing process after the completion of the synthesis where EtOH washes away the excess CTAB/CTAC.

Similar results were observed by substituting the r-PP film for t-PP film.

### Contact Angle and Durability

Contact angles were measured to determine the hydrophobicity of the resulting MSP-FTS layer (Table 9). Initially all MSP coated samples showed excellent super-hydrophobic properties where the droplet rolled off the surface while Table 1, sample 1 (SiO₂ coated sample) showed very good super-hydrophobic results (149±1°). The durability of the samples was also measured using contact angle measurements as mentioned in the characterizations section. After the first tape test a slight decrease is discerned in the film's hydrophobic activity. MSP coated samples (Table 1, samples 2-6) still managed to retain their super-hydrophobic characteristics since all their contact angles remained 150° and above as opposed to sample 1 which showed a significant decrease (135±3 0). The contact angles continued to decrease for all samples after 3, 10 and 25 tape tests although samples 2-5 still managed to stay relatively stable throughout the durability test, showing contact angles between 145° to 140° after 25 tape tests. The reason for the difference between the MSP coated samples (Table 1, samples 2-6) and those coated with SiO₂ particles (sample 1) is due to their surface roughness and topography. MSP coated samples, having very rough surfaces, can retain enough of their roughness even if some of the SiO₂ structures are lost during the durability test while SiO₂ particle coated samples have significantly less surface roughness that they can afford to lose. These results demonstrate the importance of the addition of CTAB during the SiO₂ layer fabrication process in achieving durable super-hydrophobic coatings that can be used for industrial purposes.

TABLE 11
Measured initial contact angles and contact angles after performing
the durability test (tape test) for samples 1-6 (Table 1) after
the binding of the FTS layer. The drop volume used was 3 μL.

| Number of tape tests* | Contact angle (°) | | | | |
|---|---|---|---|---|---|
| Sample | 0 | 1 | 3 | 10 | 25 |
| 1 | 149 ± 1 | 135 ± 3 | 133 ± 3 | 133 ± 2 | 132 ± 2 |
| 2 | >150** | 150 ± 1 | 146 ± 4 | 142 ± 5 | 141 ± 2 |
| 3 | >150 | 155 ± 4 | 148 ± 2 | 147 ± 3 | 145 ± 1 |
| 4 | >150 | 152 ± 2 | 147 ± 1 | 146 ± 3 | 142 ± 2 |
| 5 | >150 | 152 ± 5 | 144 ± 1 | 142 ± 3 | 140 ± 4 |
| 6 | >150 | 150 ± 4 | 146 ± 5 | 143 ± 2 | 138 ± 2 |

*The numbers correspond to the number of times a tape test was performed on the film.
**The droplet rolled off the film which prevented accurate measurements of their contact angle.

In addition, hydrophilic and superhydrophobic coatings were also produced in one step (instead of two steps as previously described), by using a modified Stöber method in presence of the former hydrophobic silanes, e.g., FETES or OTES, in presence or absence of a mesoporous producing surfactant, e.g., CTAB or CTAC, in the presence of a surface oxidized, e.g. corona, treated polymeric films. Here, again the MSP coated films far outperformed the SiO₂ particle coated films in hydrophobic/superhydrophobic properties both initially and prior to the durability tests.

Similar results were observed by substituting the r-PP film for t-PP film.

Similar results were obtained when substituting CTAB/CTAC for other mesoporous producing surfactants.

Similar results were obtained when substituting PP films for PE, PC, PMMA, PET, PS, PVC and other polymeric films.

Similar results were obtained when substituting FTS for FTES, OTS for OTES and for other silane compounds containing hydrophobic chains and other chemical groups that can undergo hydrolysis and condensation.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A coated substrate comprising a substrate, and a silane-based polymer, wherein:
i) said silane-based polymer is covalently bound to at least a portion of said substrate, forming a coating layer, and
ii) said silane-based polymer is represented by or comprises Formula I: 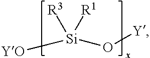
wherein:
x represents an integer between 2 and 10.000;
each Y′ independently represents H or a covalent bond to the substrate; R³ comprises an aromatic UV absorbing functional group;
R¹ represents hydrogen, or is selected from the group comprising -----O, optionally substituted C₁-C₆ alkyl, —O(C₁-C₆ alkyl), —OH, or a combination thereof;
represents a covalent bond to i) the substrate, or ii) to an adjacent monomer;
and wherein the silane-based polymer comprises at least one covalent bond to the substrate.

2. The coated substrate of claim 1, wherein R³ is represented by or comprises Formula Ic: 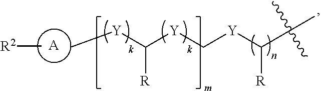
wherein:
A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl;
each Y independently represents C, CH, CH₂, or O;
n is an integer ranging from 1 to 5;
each k is an integer ranging from 0 to 5;
m is an integer ranging from 0 to 5; and
each of R and R² independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof.

3. The coated substrate of claim 1, wherein said silane-based polymer is represented by or comprises Formula II: 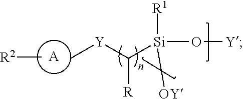
optionally wherein said silane-based polymer is represented by Formula IIIa: by Formula IIIb: 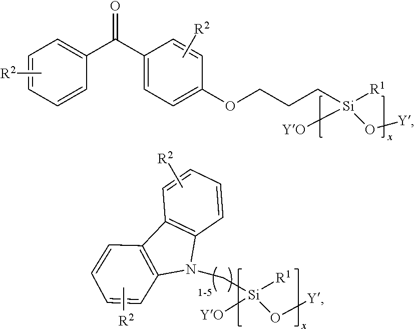
or by Formula Mc: 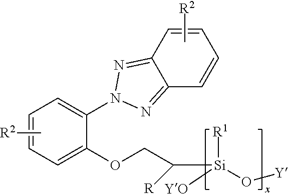
further optionally wherein said silane-based polymer is derived from a monomer represented by any one of:

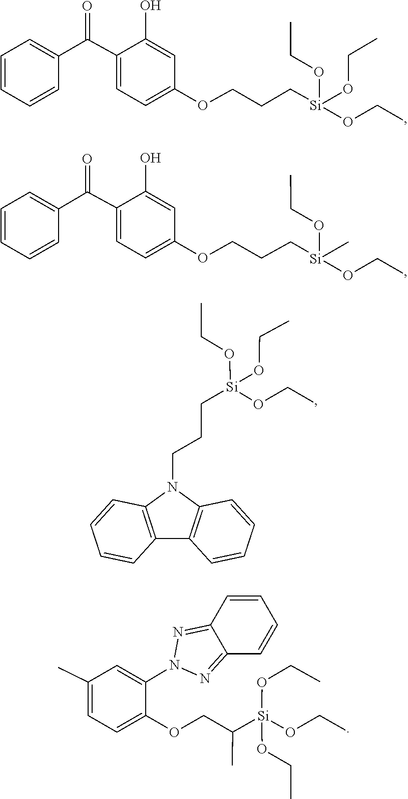

4. (canceled)

5. (canceled)

6. The coated substrate of claim 1, wherein said substrate comprises an at least partially oxidized surface comprising a plurality of hydroxy groups, and wherein said substrate is an organic polymeric substrate.

7. The coated substrate of claim 1, wherein said coating layer is characterized by a dry thickness between 0.2 μm and 50 μm, optionally wherein said coating layer comprises at least two coating layers.

8. (canceled)

9. The coated substrate of claim 1, further comprising between 0.01% (w/w) and 0.2% (w/w) of a surfactant selected from the group consisting of: cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyidimethylammonium bromide (DEDTAB), decyltrimethyl ammonium bromide(D10TAB), dodecyltriphenylphosphonium bromide (DTPB), or any combination thereof.

10. (canceled)

11. The coated substrate of claim 6, wherein said organic polymeric substrate comprises a polymer selected from the group consisting of: polyethylene (PE), polypropylene (PP), polyethylene terephthalate (PET), PET derivatives, polymethylmethacrylate(PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

12. The coated substrate of claim 1, wherein said coating layer is characterized by at least one of: an ultraviolet (UV) transmission of less than 60%; a visible light transmission (VLT) between 80% and 99%; a haze between 6% and 20%. a shrinkage between 1% and 40%, obtained by thermal shrinkage process; and improved UV-blocking transmission; optionally wherein said coated substrate is in a form of an article selected from the group consisting of: transparent plastic surface, lenses, package, and windows.

13. (canceled)

14. (canceled)

15. (canceled)

16. (canceled)

17. (canceled)

18. (canceled)

19. A process for obtaining the coated substrate of claim 1, comprising the steps of:
(a) providing at least partially oxidized substrate comprising a plurality of hydroxy groups; and
(b) contacting said substrate with a composition comprising: (i) a silane-based monomer, wherein said silane-based monomer is represented by or comprises Formula Id: 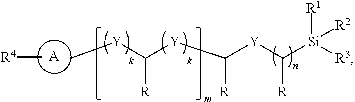
wherein:
A comprises an aromatic ring, a fused aromatic ring, a fused heteroaromatic ring, a heterocyclic ring, a fused ring comprising a cycloalkyl, bicyclic cycloalkyl, heterocyclyl, or a bicyclic heterocyclyl; each Y independently represents C, CH, CH₂, or O; n is a integer ranging from 1 to 5; each k is a integer ranging from 0 to 5; m is a integer ranging from 0 to 5; each of R¹, R², R³ independently represents hydrogen, or is selected from the group comprising optionally substituted C₁-C₆ alkyl, —O(C₁-C₆ alkyl), —OH, or a combination thereof, wherein at least one R′, R² or R³ represents said substituent; and each of R, R⁴ independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; and (ii) a solvent, a surfactant or both, under conditions suitable for said silane-based monomer to polymerize and covalently bound to said substrate, thereby forming a coating layer on said substrate.

20.-33. (canceled)

34. A coated substrate comprising a substrate and mesoporous SiO₂-coating, wherein:
i) said mesoporous SiO₂-coating is covalently bound to at least a portion of said substrate, forming a first coating layer;
ii) said first coating layer is characterized by a dry thickness between 0.001 μm and 10 μm; and
iii) said first coating layer is characterized by a roughness between 1 nm and 100 nm, as measured by Atomic Force Microscope (AFM).

35. The coated substrate of claim 34, wherein said substrate is selected from the group consisting of: a polymeric substrate, a paper substrate a glass substrate, and any combination thereof.

36. The coated substrate of claim 35, wherein said polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), silicon rubber, high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

37. The coated substrate of claim 35, wherein said coated substrate is characterized by a water contact angle on the surface of said first coating layer of less than 40°.

38. The coated substrate of claim 35, wherein said coated substrate is characterized by a water contact angle on the surface of said first coating layer between 40° and 1°.

39. The coated substrate of claim 35, further comprising a second coating layer, comprising a hydrophobic agent selected from 1H,1H,2H,2H-perfluorododecyl trichlorosilane (FTS), octadecyl trichlorosilane (OTS), 1H,1H,2H,2H-perfluorodecyl triethoxysilane (FTES), octadecyl triethoxysilane (OTES), and any combination thereof.

40. The coated substrate of claim 39, wherein said hydrophobic agent is covalently bound to said mesoporous SiO₂-coating, or to said first coating layer.

41. The coated substrate of claim 39, wherein said coated substrate is characterized by at least one of: a water contact angle on the surface of said second coating layer of at least 130°; a water contact angle on the surface of said second coating layer between 130° and 165°; a roughness between 70 nm and 150 nm, as measured by AFM; haze between 8.5% and 20% and gloss between 25% and 49%.

42.-67. (canceled)
